(19) United States
(12) Patent Application Publication
(10) Pub. No.: US 2025/0392250 A1
(43) Pub. Date: Dec. 25, 2025

(54) TERRAIN FOLLOWING SUPPORT SYSTEMS AND INSTALLATION METHODS FOR SOLAR ENERGY MODULES

(71) Applicant: PEGASUS SOLAR INC, Richmond, CA (US)

(72) Inventors: Erich Kai Stephan, Richmond, CA (US); Ian Wogan, Richmond, CA (US)

(21) Appl. No.: 19/218,138

(22) Filed: May 23, 2025

Related U.S. Application Data
(60) Provisional application No. 63/663,664, filed on Jun. 24, 2024.

(51) Int. Cl. H02S 20/30; H02S 30/10

(52) U.S. Cl. CPC H02S 20/30; H02S 30/10

(57) ABSTRACT

Embodiments of an apparatus for securing solar modules at variable angles relative to a terrain comprising a module clip and a swivel bracket are described herein. The module clip may include a first side wall and a second side wall that includes one or more solar module flange apertures each configured to receive a solar module flange, a hem that joins the first side wall and the second side wall at an angle, and one or more tabs. The swivel bracket is configured to support a solar module. The swivel bracket may include bracket walls through which an aperture extends, the aperture configured to receive the module clip when the module clip is in the compressed state and to retain the module clip when the module clip is in the uncompressed state, wherein the module clip is secured to an underside of the swivel bracket by the tabs.

### CROSS-REFERENCE TO RELATED APPLICATIONS

The present patent application claims the priority benefit of U.S. provisional patent application No. 63/663,664 filed Jun. 24, 2024, the disclosure of which is incorporated by reference herein.

### BACKGROUND OF THE INVENTION

Currently, solar modules are supported at an angle relative to the horizon set by the geometry of a support bracket and underlying substructure. Often, these use excessive materials to support the solar energy modules, and they do so in a way that can compromise the strength of the modules. In addition, known support structures are typically unable to follow the contour of the underlying terrain. The present invention is a system that supports solar energy modules at an optimal angle for total energy capture from the sun over the duration of a day while accommodating the contours of the underlying terrain and minimizing the need for any adaptations to the terrain.

### SUMMARY OF THE CLAIMED INVENTION

Embodiments of an apparatus for securing solar modules at variable angles relative to a terrain comprising a module clip and a swivel bracket are described herein. The module clip may include a first side wall that includes one or more solar module flange apertures each configured to receive a solar module flange, a second side wall that includes one or more solar module flange apertures each configured to receive a solar module flange, a hem that joins the first side wall and the second side wall at an angle relative to each other, wherein the hem is compressible between an uncompressed state and a compressed state, and wherein the angle in the compressed state is smaller than the angle in the uncompressed state, and one or more tabs.

The swivel bracket is configured to support a solar module. The swivel bracket may include one or more bracket walls through which an aperture extends, the aperture configured to receive the module clip when the module clip is in the compressed state and to retain the module clip when the module clip is in the uncompressed state, wherein the module clip is secured to an underside of the swivel bracket by the one or more tabs. The swivel bracket may be configured to pivotally connect to a stilt coupler, wherein the pivot connection allows the at least one side wall to rotate about a first axis. The swivel bracket may include one or more curved hems each extending along a respective edge of the at least one side wall, wherein the curved hems are configured to pivotally support a solar module, and wherein the supported solar module is rotatable around a second axis that is perpendicular to the first axis.

### BRIEF DESCRIPTION OF THE DRAWINGS

FIG. 1A illustrates an isometric view of an embodiment of a solar module array.

FIG. 1B illustrates an end view of an embodiment of the solar module array installed on an undulating terrain.

FIG. 1C illustrates an isometric view of an embodiment of the solar module array with the solar modules removed.

FIG. 1D illustrates an isometric view of an embodiment of the solar module array installed on an undulating, uneven, sloped terrain.

FIG. 2 illustrates a top-down view of a solar module array indicating zones where wind forces applied to the solar module array may differ among the zones.

FIG. 3A and FIG. 3B illustrate isometric and plan views of an end swivel bracket 106 representing one example embodiment of the present invention.

FIG. 4A-FIG. 4D illustrate isometric, plan, and top-down views of a mid-swivel bracket 107 within the scope of the present invention.

FIG. 5A-FIG. 5C illustrate a mid swivel bracket.

FIG. 6 illustrates an isometric view of a single bracket coupler.

FIG. 7A-FIG. 7D illustrate the installation of a swivel bracket.

FIG. 8 illustrates a top-down views of several crimp patterns.

FIG. 9 illustrates a side view of a solar module array.

FIG. 10A and FIG. 10B illustrate isometric and end views of a module clip.

FIG. 11A-FIG. 11D illustrate a sequence for mounting a solar module to a plurality of swivel brackets using one or more module clips.

FIG. 12A-FIG. 12E illustrate an example of an installation apparatus and an illustrative sequence for installing a module clip on a swivel bracket.

FIG. 13A and FIG. 13B illustrate an alternative example of the side access aperture on a swivel bracket.

FIG. 14A-FIG. 14D illustrate isometric, end, and side views of an alternative module clip.

FIG. 15A-FIG. 15G illustrate front, side view and isometric views of a module clip being installed on a swivel bracket.

FIG. 16A-FIG. 16D illustrate end and isometric views of two module clips installed on a swivel bracket.

FIG. 17A-FIG. 17G illustrate various views of a module lifter.

FIG. 18A-FIG. 18D illustrate isometric, end, and side views of a solar module being mounted to a plurality of swivel brackets using a module lifter.

FIG. 19A and FIG. 19B illustrate the lifter support arms.

FIG. 20A and FIG. 20B illustrate an alternative embodiment of a module clip.

FIG. 21A-FIG. 21D illustrate an exemplar module lifter.

FIG. 22A and FIG. 22C illustrate isometric and end views of a corner section of a solar module array.

FIG. 23A and FIG. 23B illustrate isometric views of a support cable supported by aligned cable holders.

FIG. 24A-FIG. 24E illustrate various views of an alternative solar module array using an extended mid swivel bracket.

FIG. 25 illustrates an isometric view of an extended mid swivel bracket installed on a stilt.

FIG. 26A-FIG. 26C illustrate views of a solar module array with solar modules in portrait orientation.

FIG. 27A and FIG. 27B illustrate isometric views of a swivel bracket.

FIG. 28A-FIG. 28D illustrate isometric views of an alternative interface between a stilt and a swivel bracket.

FIG. 29 illustrates an isometric view of an installation jig.

FIG. 30A-FIG. 30C illustrate a method of using the installation jig.

FIG. 31 illustrates an isometric view of an alternative swivel bracket within the scope of the invention.

FIG. 32A and FIG. 32B illustrate isometric views of the universal swivel bracket.

FIG. 33A and FIG. 33B illustrate end views of the universal swivel bracket.

FIG. 34A and FIG. 34B illustrate isometric and end views of an equatorial facing solar array.

FIG. 35A and FIG. 35B illustrate isometric views of the universal swivel bracket from above and below.

FIG. 36A and FIG. 36B illustrate assembled and exploded isometric views.

FIG. 37A and FIG. 37B illustrate isometric views from above of three equatorial facing solar arrays.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

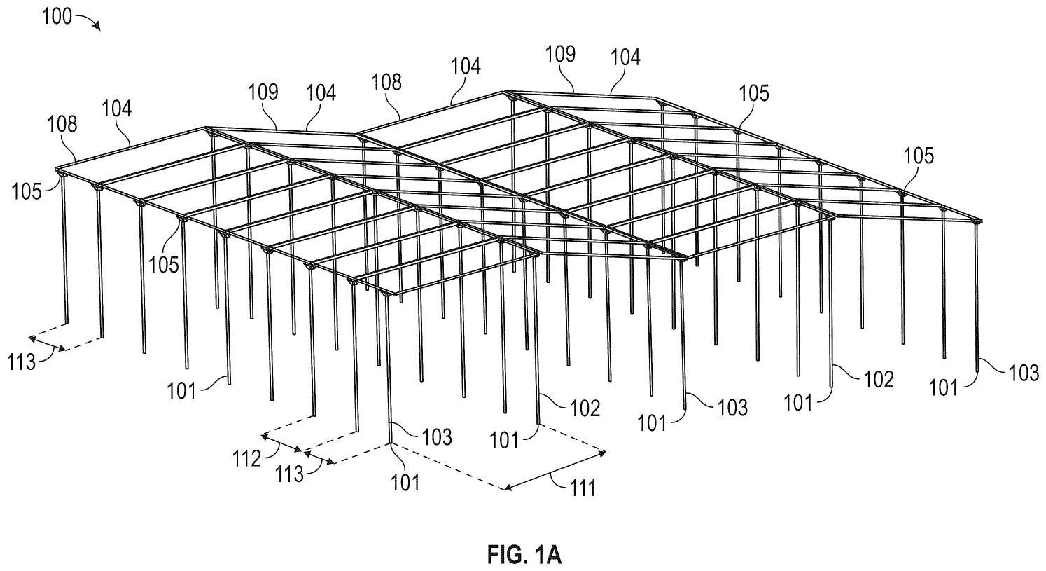

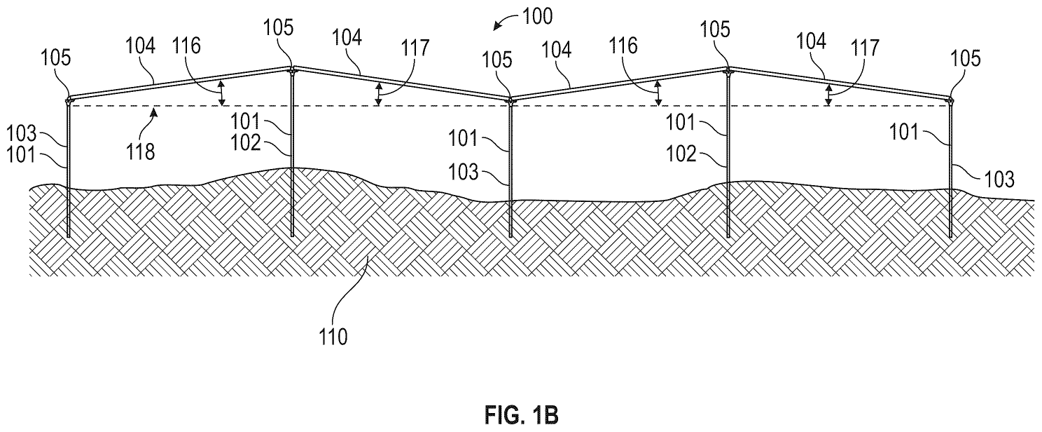

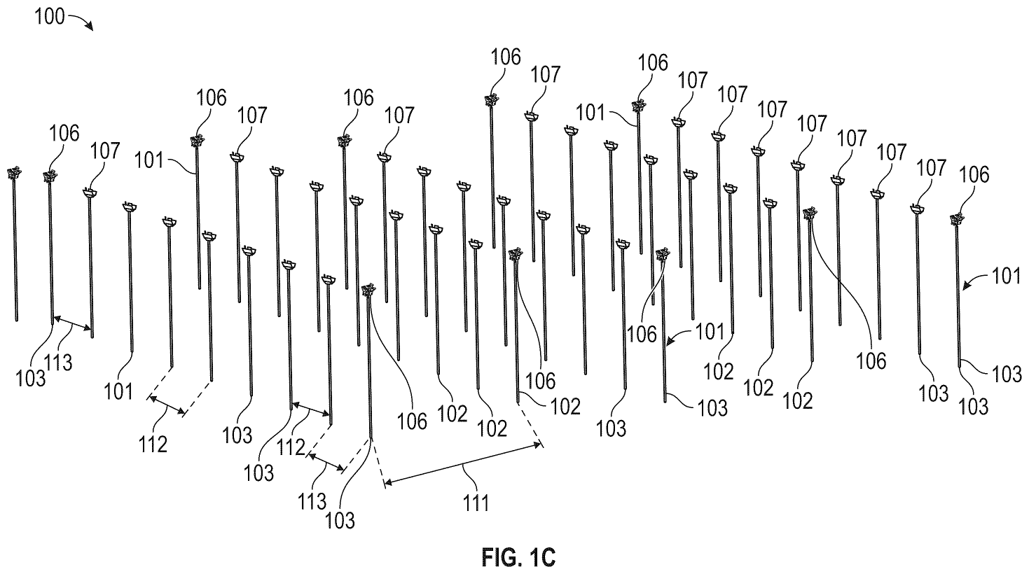

FIG. 1A is an isometric view of a solar module array 100: FIG. 1B is an end view of the solar module array installed on an undulating terrain 110; FIG. 1C is an isometric view of the solar module array with the solar modules themselves removed to show the underlying stilts supporting the array; and FIG. 1D is an isometric view of the solar module array installed on an undulating, uneven, or sloped terrain 110, again with the solar modules removed. The solar module array 100 is supported by a plurality of stilts 101 arranged in columns and rows, with the solar modules 104 connected to the stilts 101 by swivel brackets 105. The stilts 101 may have one or more configurations, such as long stilts 102 and short stilts 103. In some embodiments, the long stilts 102 and short stilts 103 may be different lengths, and in other embodiments the long stilts 102 and short stilts 103 may be the same length but penetrating the terrain 110 to different depths such that the resulting height, or reveal, above the terrain 110 is different. In yet another example embodiment as depicted in FIG. 1B, a column of long stilts 102 may penetrate the terrain 110 to a depth such that the distal (upper) ends of the column are all substantially at a first elevation even if the terrain 110 is undulating, uneven, or sloped, and a column of short stilts 103 may likewise penetrate the same terrain to a depth such that the upper ends of the short stilts are all substantially at a second elevation, the second elevation being on average higher above terrain than the first elevation. As shown in FIG. 1C, the long stilts 102 may be arranged into a first series of substantially linear columns, where the stilts at one end of a single column are spaced apart by an NS distance 113, the stilts at mid-column are spaced apart by a different NS distance 112, the stilts at the second end of the column are spaced apart by a third NS distance 103, and the stilts of adjacent columns are spaced apart by an east-west (EW) distance 111. The NS distances 103, 112 and 113 may be the same, or the end NS distances 103, 113 may be less than NS distance 112 at mid-column. The NS distance 112 at mid-column may be equal to the width of a module plus the distance between two adjacent solar modules. The NS distance 113 at the column end may be less than NS distance 112 at mid-column so that the first and last stilts in the column are positioned inwards from the corner of a solar module 104 by 1 to 600 millimeters from the corner of the solar module.

A second column of stilts 101 may be configured as long stilts 102, wherein the NS distance 112 between the long stilts at mid-column and the NS distance 113 between the long stilts at the column end are substantially similar to the corresponding distances in a column of short stilts. The EW distance 111 between stilts of adjacent columns may be equal to a module length plus the gap between module columns, resulting in solar modules 104 being substantially parallel with the terrain 110, and the long stilts and short stilts all being at substantially the same elevation above the terrain. Alternatively, the EW distance 111 may be less than the combination of the module length 114 and the gap between the module columns, resulting in the solar module 104 being at a west-facing module tilt angle or an east-facing module tilt angle relative to the horizon 118. The EW distance 111 between adjacent columns may be chosen so the upper ends of the stilts in these columns are at different elevations above the horizon, such that a first column of solar modules 104 installed on these stilt columns are at West module tilt angle 116. In some embodiments, this first column of solar modules 104 may be a west-facing module column 108 by facing within 45 deg of due West, while the third column of stilts is positioned to place the second column of solar modules at an opposite angle to the horizon and thereby east-facing. The West module tilt angle 116 and the East module tilt angle 117 may be equal and opposite angles, or the two tilt angles may differ from each other. A processor 101 may be used to execute an algorithms, code, or commands stored in the memory 102. The processor 101 may also be configured to decode and execute any instructions received from one or more other electronic devices, server(s), sensors, or other connected devices. The processor 101 may include one or more general purpose processors (e.g., INTEL®; or Advanced Micro Devices®; (AMD) microprocessors. ARM) and/or one or more special purpose processors (e.g., digital signal processors. Xilinx®; System On Chip (SOC) Field Programmable Gate Array (FPGA) processor, and/or Graphics Processing Units (GPUs)). The processor 101 may be configured to execute one or more computer-readable program instructions, such as program instructions to carry out any of the functions described in this description.

In other example embodiments not shown, the solar modules 104 may be rotated 90 degrees and installed in a landscape orientation, wherein the NS distance 112 at mid-column may be equal to the module length 114 plus the distance between two adjacent solar modules 104 and the EW distance 111 between adjacent columns may be equal to the module width 115 plus the gap between module columns.

Long stilts 102 and short stilts 103 may be installed in a terrain 110 such that the solar modules 104 are above the terrain 110 at an elevation sufficient for a person to crawl or slide underneath the modules to access a solar module 104 in the middle of a solar module array 100. For example, the average or minimum elevation of a solar module 104 above the terrain 110 may be as low as 1 inch, or as high as 100 inches. In other example embodiments, a solar module 104 may coincident or within 0.5 inches of the terrain 110 along one edge or on all edges of the module. A first column of short stilts and a last column of short stilts may be installed into the terrain so the upper ends of the stilts of both columns are at a lower elevation than the upper ends of the stilts of the middle columns. This arrangement may thus produce a west-facing module column 108 on the west-most side of the solar module array and an east-facing module column 109 on the east-most side of the array with higher West and East tilt angles than the tilt angles of the middle module columns. The west-most and east-most short stilt columns may be installed so their upper ends are at zero to 30 inches above the terrain while the middle short-stilt columns may have upper ends at 12 to 90 inches above the terrain. In this way, the first and last columns of solar modules that would otherwise funnel wind underneath the solar module array may instead deflect the wind up and over the array 100.

Referring to FIG. 1A, the solar module array in some example embodiments may be configured with an equal number of west-facing module columns 108 and east-facing module columns 109, such that the West-most column of solar modules 104 is a west-facing module column 108 and the East-most column of solar modules 104 is an east-facing module column 109. Each solar module 104 may have a maximum production voltage which is the maximum voltage that a single solar module may produce and be rated to a maximum system voltage which is the maximum voltage capacity of a plurality of solar modules that are connected electrically in series. A west-facing module column 108 or an east-facing module column 109 may have a quantity of solar modules equal to or less than the maximum system voltage divided by the maximum production voltage. For example, if a solar module has a maximum production voltage of 49.8 volts, and a maximum system voltage of 1500 volts, then 1500 divided by 49.8 volts equals 30.12, which rounds down to 30 solar modules 104 electrically connected in series for a west-facing module column 108 or an east-facing module column 109. Each west-facing module column 108 in a solar module array 100 may be electrically connected in parallel to a first electrical inverter, thereby maintaining the total voltage of each west-facing module column 108 but increasing the amperage delivered to the first inverter. Likewise, each east-facing module column 109 in a solar module array 100 may be electrically connected in parallel to a second electrical inverter, thereby maintaining the total voltage of each west-facing module column 108 but increasing the amperage delivered to the second inverter. A solar module array may have a quantity of west-facing module columns 108 electrically connected in parallel to deliver a desired maximum amperage, which may be limited to the maximum amperage capacity of an inverter. In other examples where the quantity of solar modules 104 in a west-facing module column 108 does not exceed the maximum system voltage of a solar module 104, a first west-facing module column 108 may be electrically connected in series to a second west-facing module column 108. For example, using the previously stated voltage capacities, a first west-facing module column 108 with fifteen solar modules 104 may be electrically connected in series to a second west-facing module column 108 with fifteen solar modules 104 to maximize the potential voltage produced while not exceeding the maximum voltage capacity of a solar module 104.

Solar modules that are bifacial, producing electricity from light hitting incident on both the front and back surfaces of the module, may be used. In other examples, monofacial solar modules may be used. The solar modules may include mono-crystalline, poly-crystalline, or thin-film photovoltaic technology. The modules may have an aluminum or steel frame pre-installed on all four sides of the photovoltaic laminate, or no external frame, and be made from two pieces of glass laminated together encapsulating a plurality of photovoltaic cells or encapsulating a deposition photovoltaic material.

The stilts may be circular tubes, square tubes, rectangular tubes, hexagonal tubes, solid rods, or tubes of any other cross section. Stilts may be made from steel, aluminum, or other metals, and may have a painted coating, a galvanized coating, or a coating of any material that prevents corrosion. An anti-corrosion coating may cover all surfaces of the stilt, or all except the stilt ends. The stilts may be manufactured in long lengths, such as 20 to 100 feet long, followed by application of the anti-corrosion coating, then cut into shorter sections, such as 70 to 90 inches long, for transport, leaving the cut ends of each stilt uncoated. A stilt may be hollow and have a uniform wall thickness along its length. A stilt may have a moment capacity to prevent yielding or buckling when the solar module array is subject to wind forces at speeds of up to 180 miles per hour and the solar modules are installed with West and East module tilt angles of 15 degrees or less.

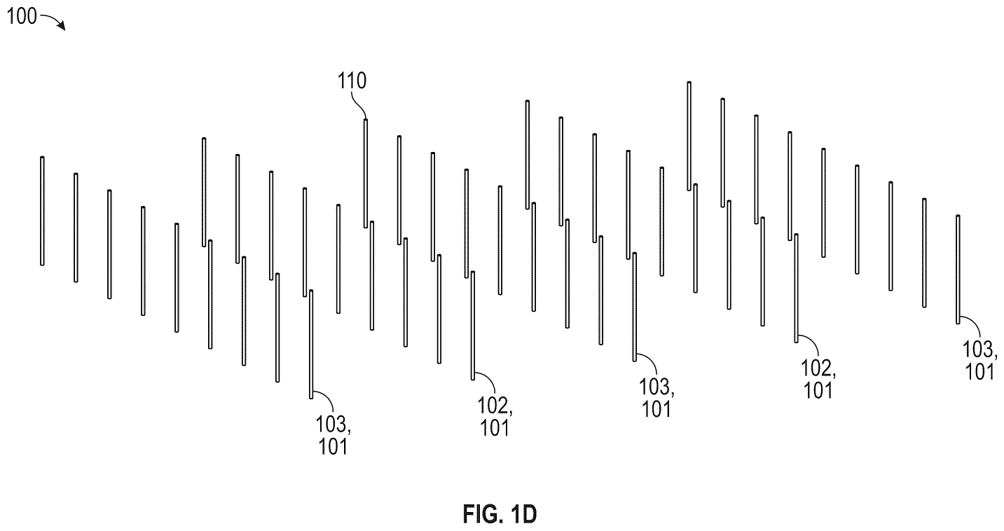

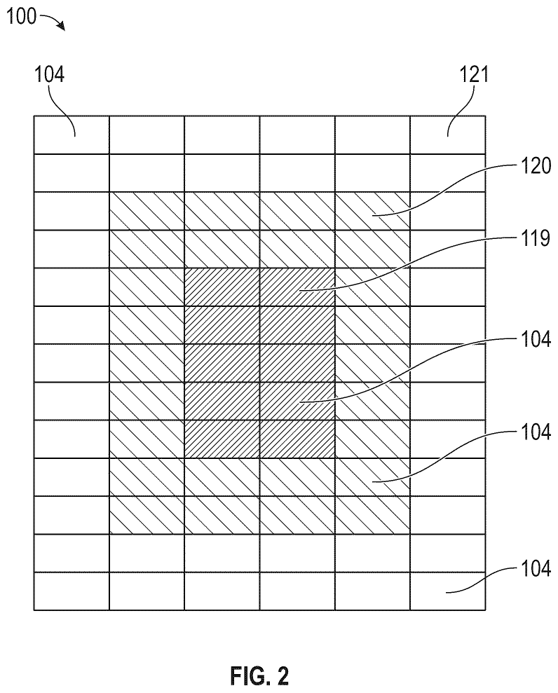

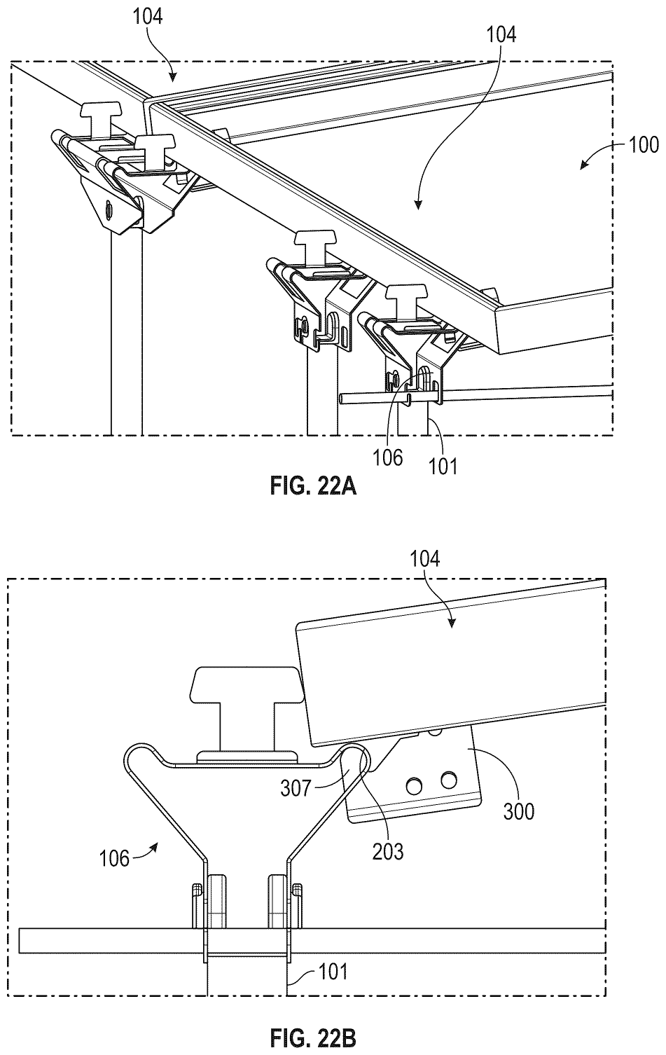

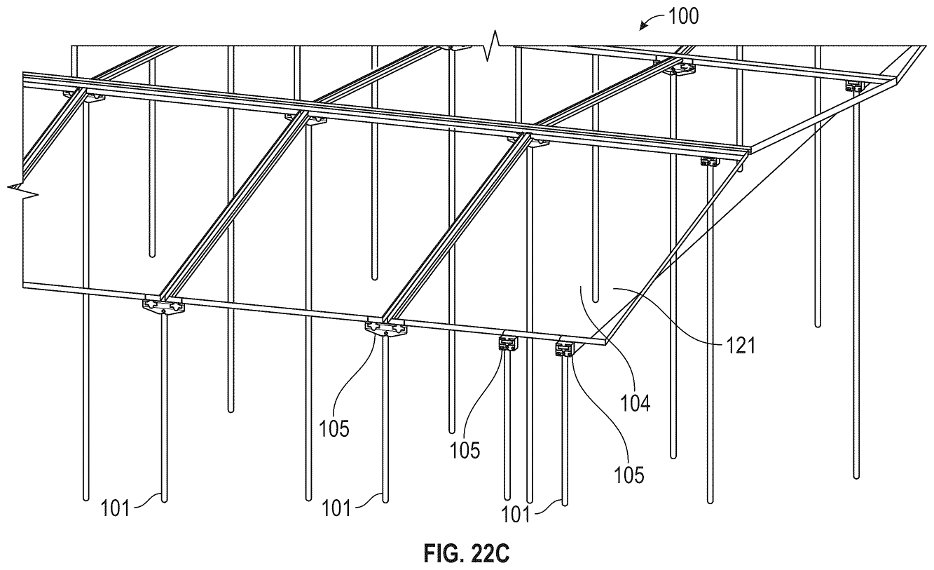

As depicted in FIG. 1C, end swivel brackets 106 may be installed on the first and last stilts 101 in each column of stilts, and a mid-swivel bracket 107 may be installed on the middle stilt 101 in each column of stilts. End swivel brackets 106 may be installed on both long stilts 102 and short stilts 103, and mid swivel brackets 107 may be installed on both long stilts 102 and short stilts 103. FIGS. 22A and 22C show stilts 101 and end swivel brackets 106 installed 1 to 600 millimeters from the south and north edges of the south and north-most solar modules 104, respectively, in Zone 3 (as described below in reference to FIG. 2).

FIG. 2 is a top-down view of a solar module array indicating zones where wind forces applied to the solar module array may differ among the zones. Zone one solar modules 119 may form a group having a circular, rectangular, or ovular shape substantially at the center of the solar module array and may be defined by a connected series of solar modules as depicted. Alternatively, the boundary of zone one may bisect any number of solar modules. The zone two solar modules 120 may reside at the perimeter of zone one in a circular, rectangular, or oval shape, and may likewise consist of a connected series of solar modules as depicted, or have a boundary that bisects any number of solar modules. Zone three 121 may reside around the outer boundary of zone two, the outer boundary of zone three forming the outer perimeter boundary of the solar module array. Wind forces may impose a pressure on the solar modules at various levels that differ among the three zones. For example, the pressure in zone two may be greater than the pressure in zone one, and the pressure in zone three may be greater than the pressure in zone two. The lowest pressure may be at or near the center of the solar module array 100, with pressures incrementally increasing to a highest pressure near the perimeter of the solar module array 100, thereby creating a pressure gradient emanating from the center point of the solar module array 100. The location of a stilt attached to a solar module 104 will define the tributary surface area of one, two, three, or four solar modules 104 associated to that stilt 101. Multiplying the tributary surface area by the pressure or pressure gradient in that specific tributary surface area will render an upward or downward force applied to a stilt 101 due to wind pressure. The stilts supporting the modules in zone three may be installed into the terrain to a deeper depth, or secured to the terrain by a different method, than the stilts 101 in zone one. For example, stilts supporting the zone three solar modules may be threaded or utilize an auger, toggle, or other device to increase the pullout force needed to pull the stilts from the terrain in this zone. Alternatively, additional stilts and swivel brackets may be deployed and connected to solar modules in the high-pressure areas, such as the solar modules 104 located at the corners of the array, as seen in FIGS. 22A and 22C.

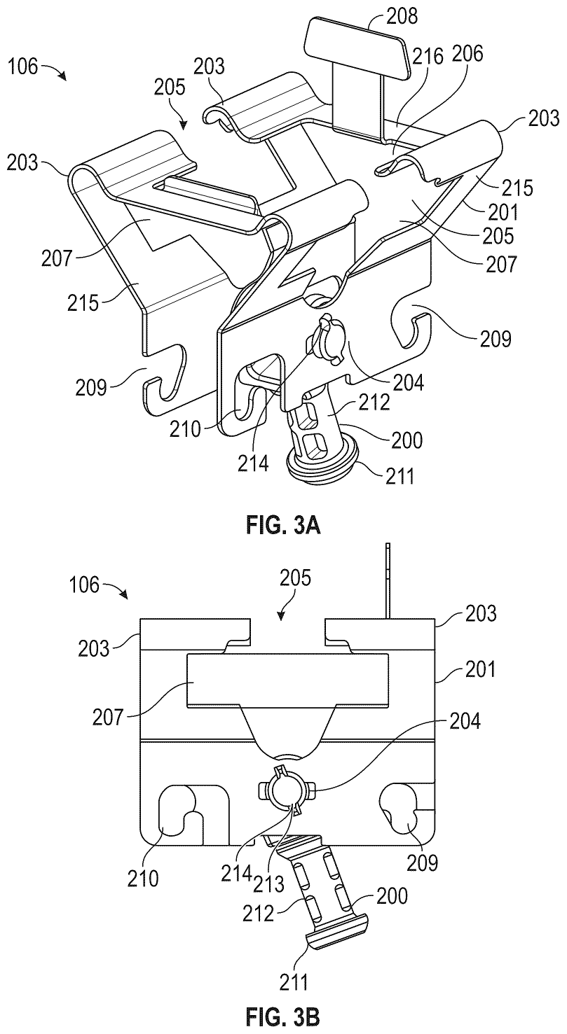

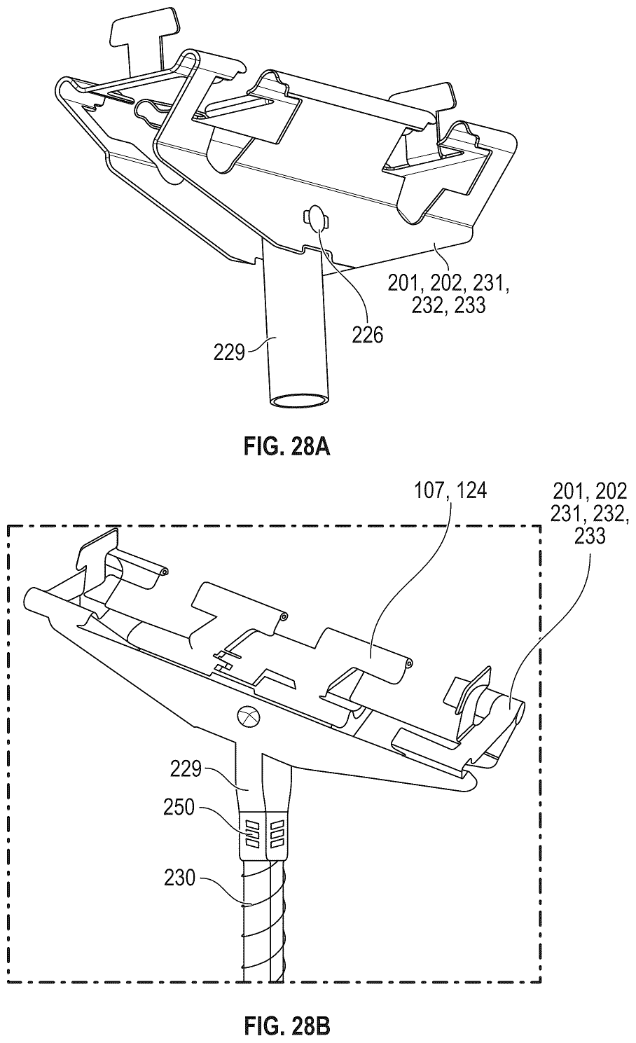

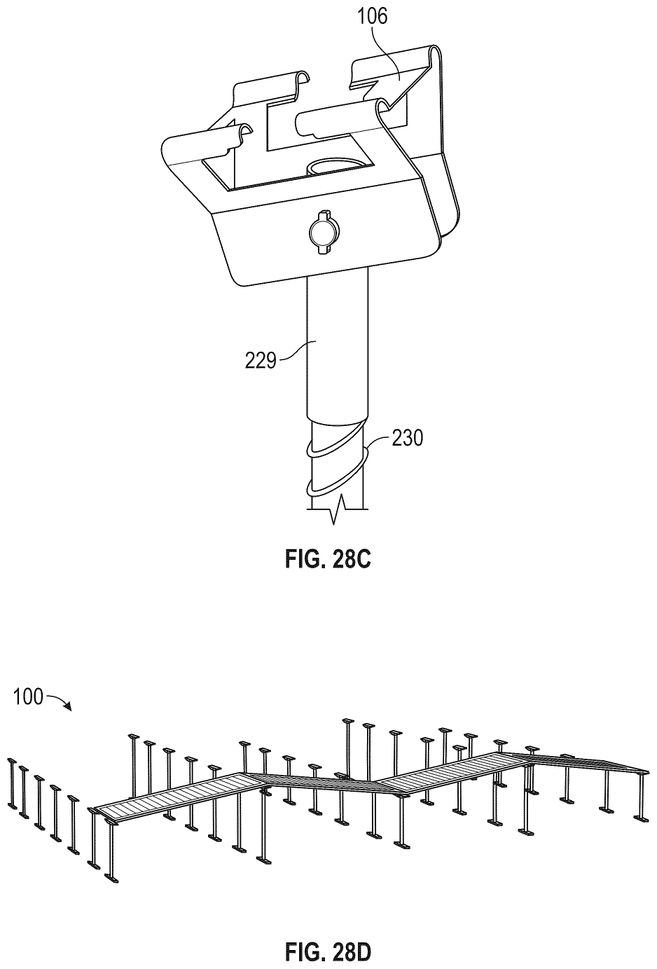

FIGS. 3A and 3B are isometric and plan views of an end swivel bracket 106 representing one example embodiment of the present invention. The end swivel bracket 106 includes a bracket coupler 200 pivotally connected to an end bracket piece 201 at an aperture 204 on the bracket coupler. The swivel bracket 106 may be pivotally connected to a crimp tube 229 as illustrated in FIG. 28A through 28D. The bracket coupler 200 and the crimp tube 229 may be referred to as a stilt coupler. A rounded flange protruding from the main body of the bracket coupler 200 has one or more coupler keyed flanges 214 at the coupler's distal end extending laterally and configured to prevent the end bracket piece 201 and the bracket coupler 200 from decoupling. A keyway aperture in the bracket coupler aperture 204 receives the keyed flange 214 on the coupler when the bracket coupler 200 is at a certain angle, such as 90 degrees, relative to the end bracket piece 201 to aid in joining the end bracket piece 201 to the bracket coupler 200.

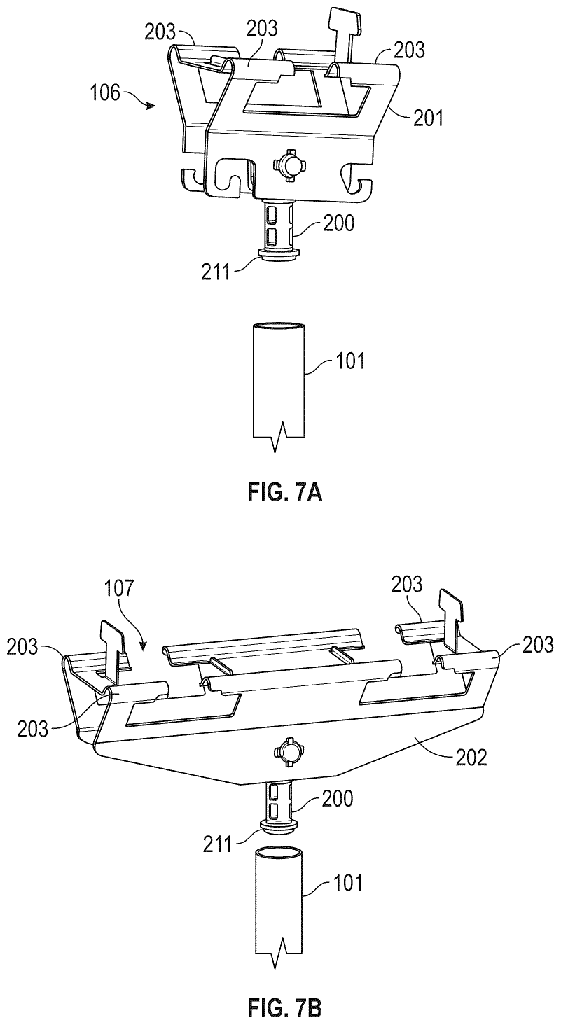

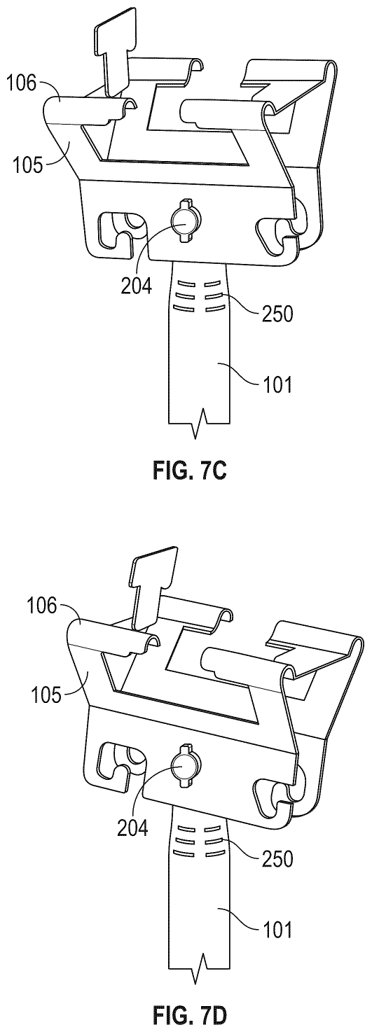

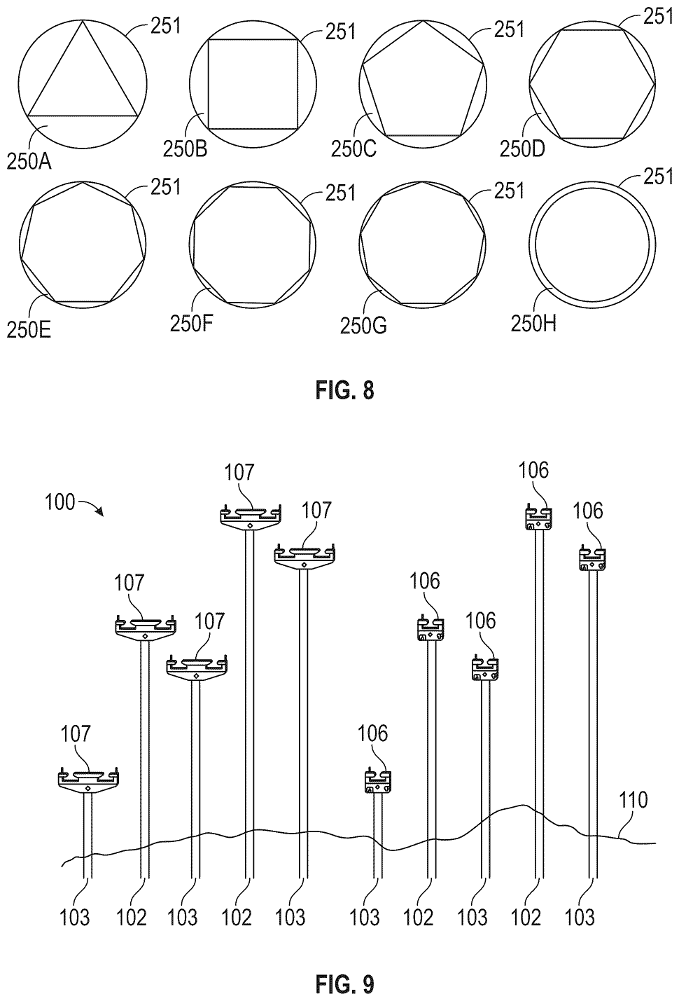

The bracket coupler 200 has a cylindrical lower body configured to fit within a hollow portion of a stilt 101. A coupler flange 211 at the lower end of the bracket coupler 200 is configured to be received into a hollow end of the stilt 101 and has a rounded or chamfered perimeter to facilitate its insertion into the stilt 101. A coupler grip section 212 is adjacent to coupler flange 211 and has an outer cross-sectional shape such as a circle, similar to that of the coupler flange 211, such as a circle, but with a smaller diameter or cross-sectional dimension. The coupler flange 211 may be configured to receive a stilt crimp 250, as shown in FIGS. 7C, 7C, and 8, after the bracket coupler 200 is inserted into the stilt 101. Referring back to FIGS. 3A and 3B, the coupler grip section 212 may have one or more cavities to reduce the material used in manufacturing. A coupler rim 213 may be disposed on the coupler grip section 212 at a location opposite that of the coupler flange 211, and the rim 213 may be substantially coincident with the inner hollow walls of the stilt 101 above the stilt crimp 250. The coupler rim 213 and the coupler flange 211 may act together to substantially center the bracket coupler 200 in the stilt 101 before or after the stilt crimp 250 is applied.

A parting line plane may bisect the bracket coupler 200 mid-body, where all surfaces on the bracket coupler 200 are either acute or obtuse to the parting line plane. For example, the side wall surfaces of the cavities in the coupler grip section 212, or the bottom surface on the coupler flange 211 may be split to have faces that are obtuse in angle to the parting line plane. The bracket coupler 200 may be manufactured from cast steel, iron, alloy steel, aluminum, polymer, or other suitable material, and it may be coated with an anti-corrosion coating such as a zinc alloy.

The end bracket piece 201 may have first and second side walls 215 connected with a top wall 216 by a hollow hem 203 on each side. Each side wall 215 may be a straight section, or may have one or more bends along its length, as shown. The outer ends of the side walls 215 may coincide with the outer surface of an upper section on the bracket coupler 200. A pair of aligned cable holders 209 and 210, configured to receive and hold a cable, may be disposed on the lower ends of the side walls as depicted in FIG. 3B.

A clip aperture 205 may be cut through the hollow hem 203 to connect to a side access aperture 207 and a top access aperture 206. The clip aperture 205 may be wider than the side access aperture 207. The top access aperture 206 may occupy a majority of the area of the top wall 216. A module spacer 208 may orthogonally protrude from the top wall 216 and set a space between two solar modules 104. The module spacer 208 may be rectangular, trapezoidal, or triangular in shape at its end to coincide with the edges of two solar modules 104 when the two solar modules 104 form a positive tilt angle.

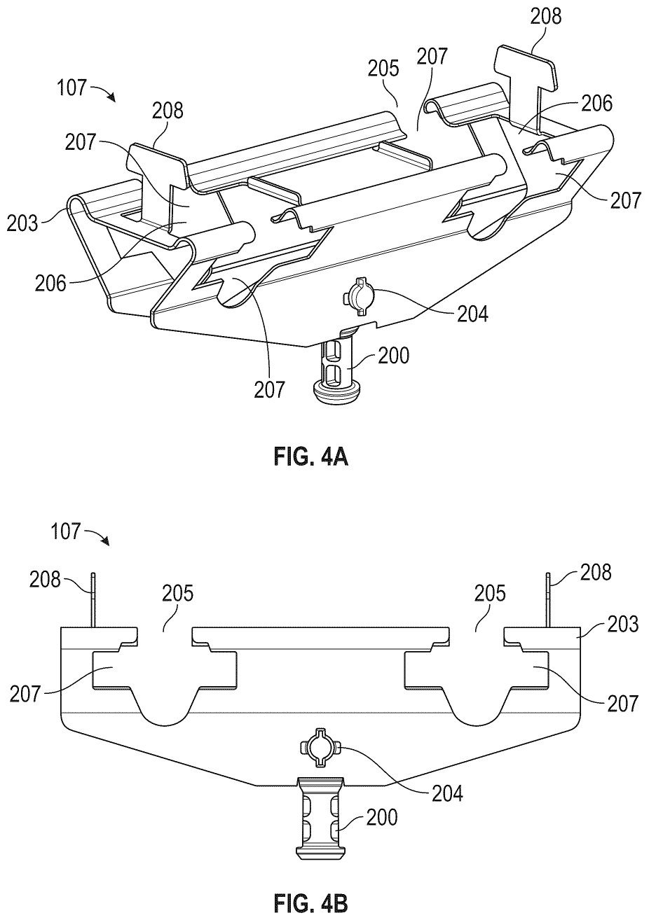

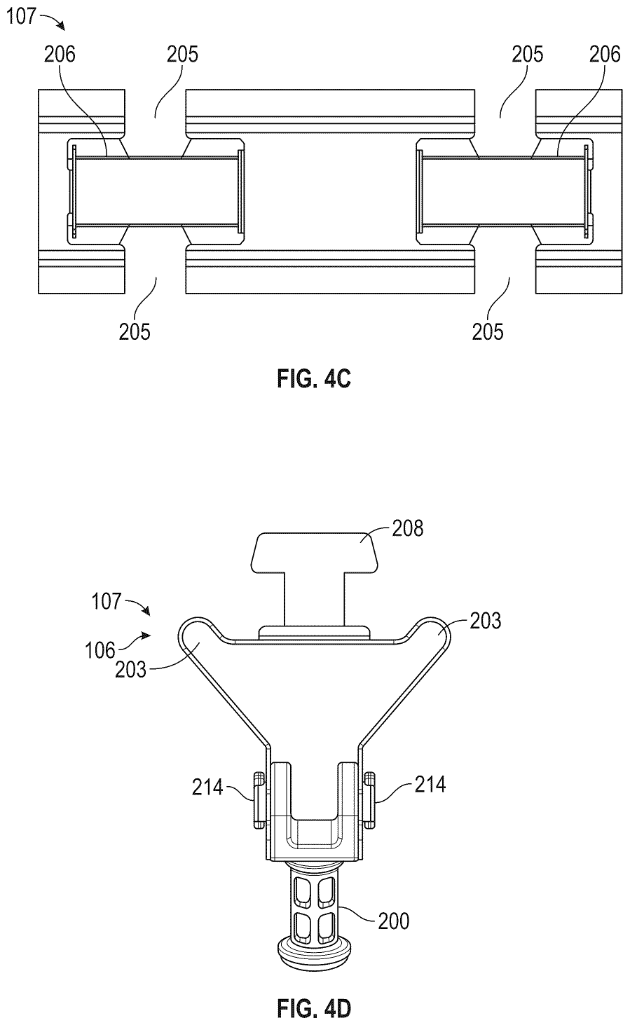

FIGS. 4A, 4B, and 4C are isometric, plan, and top-down views of a mid-swivel bracket 107 within the scope of the present invention. The mid swivel bracket 124 shares features with the end swivel bracket 106 but is configured to support up to four solar modules 104, whereas the end swivel bracket 106 is configured to support no more than two solar modules 104. The mid swivel bracket 107 has two hollow hems 203 with the same dimensions as the hollow hem 203 on the end swivel bracket 106. The mid swivel bracket 107 has a plurality of top access apertures 206, side access apertures 207, clip apertures 205, and module spacers 208. The mid swivel bracket 107 also has a bracket coupler aperture 204 disposed mid-body which couples with a bracket coupler 200 in the same manner as described above in connection with the end swivel bracket 106.

FIG. 4D is an end view of a swivel bracket 105 representing both an end swivel bracket 106 and a mid swivel bracket 107, as well as an extended mid swivel bracket 124, discussed in more detail below. The bracket may have a uniform wall thickness and may thereby be manufactured from sheet metal. Alternatively, the bracket may be manufactured using a progressive die process, a station die process, or a break press, or by casting, forging, welding, crimping, riveting, or other suitable means. The bracket may be made from pre-coated sheet metal using a coating such as zinc-flake, galvanization, paint, magnesium-zinc, magnesium-aluminum, zinc-aluminum, paint, enamel, zinc alloy, or other suitable corrosion protection layer, to provide corrosion protection. In certain embodiments, the corrosion projection layer is electrically conductive. The corrosion protection layer may be applied to the sheet metal when in a flat or coil form, and the swivel bracket 105 may then be formed from the sheet metal after the corrosion protection layer has been applied. Alternatively, the bracket may first be formed to the desired shape and then coated with the corrosion protection layer. In some embodiments, the corrosion protection layer may only be on the inner and outer surfaces of the bracket and not on any thin edges such as cut edges. The bracket may be made from aluminum, a stainless-steel alloy, a polymer, an iron alloy, or any other suitable material.

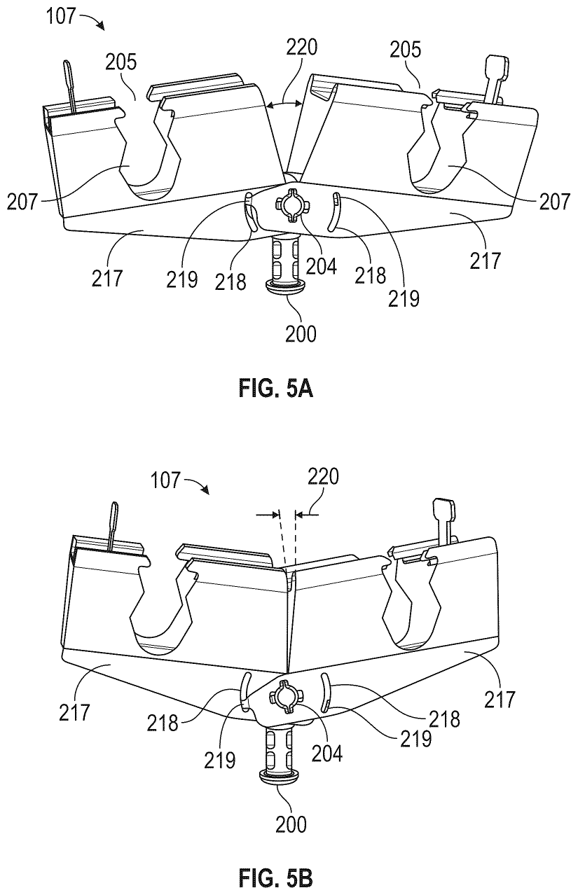

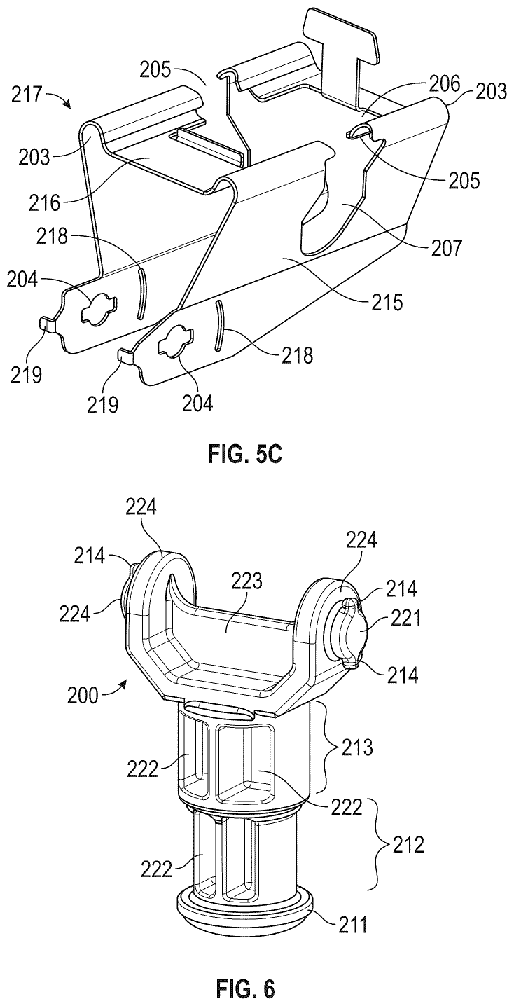

FIGS. 5A through 5C and 6 show a mid swivel bracket 107 split into two pieces for additional articulation. In this example embodiment, the mid swivel bracket 107 consists of a pair of articulating mid-brackets 217 connected to the bracket coupler 200. A pair of bracket coupler apertures 204 are on outwardly protruding flanges of the side wall 215 to pivotally receive a pair of coupler axial protrusions 221 (FIG. 6). The articulating mid-brackets 217 may independently pivot or rotate about the axis of the bracket coupler aperture 204, causing an angle limiter tab 219 of a first articulating mid-bracket to traverse along a first angle limiter aperture 218 of a second articulating mid-bracket until the first articulating mid-bracket abuts one or another end of the first angle limiter aperture 218. The arc distance of the traversal path of the angle limiter tab 219 relative to the angle limiter aperture 218 may define a maximum and minimum mid-bracket angle 220. The mid-bracket angle 220 may have a minimum angle of 0 degrees up to a maximum angle of 30 degrees. The interference of a first articulating mid-bracket with a second articulating mid-bracket may define the minimum mid-bracket angle 220, and the abutment of the angle limiter tab 219 to an end of the angle limiter aperture 218 may define the maximum mid-bracket angle 220. As depicted, bracket coupler 200 may pivotally rotate about the axis of the bracket coupler aperture 204 to any angle relative to a first or second articulating mid-bracket 217, or in other embodiments not shown, the bracket coupler 200 may be limited to rotate to a defined angle. FIG. 5A shows a pair of articulating mid-brackets 217 at a maximum mid-bracket angle 220, and FIG. 5B depicts a pair of articulating mid-brackets 217 at a minimum mid-bracket angle 220.

FIG. 5C is an isometric view of a single articulating mid-bracket 217 with a pair of aligned bracket coupler apertures 204 and a pair of aligned angle limiter apertures 218. Articulating mid-bracket 217 may have a pair of angle limiter tabs 219 that protrude in the same direction, as depicted or in opposing directions.

FIG. 6 is an isometric view of a single bracket coupler 200. The coupler rim 213 on this coupler is extended in length and has a plurality of coupler grip sections 212 on its surface. A coupler cross rib 223 spans a parting line plane between vertical flanges 224 that support a coupler axial protrusion 221. One or more coupler keyed flanges 214 protrude laterally from the coupler axial protrusion 221. These coupler keyed flanges are spaced apart from the vertical flanges 224 by a distance that is slightly greater than the thickness of a side wall 215 on an end swivel bracket 106 or a mid swivel bracket 107, or within +/−50% of two times the thickness of the side wall 215 in the case of an articulating mid-bracket 217. The vertical flanges 224 may be spaced apart from one another by a distance greater than the cross-sectional width of a stilt 101 to prevent bracket coupler 200 from entering the stilt, or rather so that the end of the stilt may abut the intersection of the vertical flanges 224 and the coupler rim 213.

FIGS. 7A through 7D depict the installation of a swivel bracket 106, 107 to a stilt 101, by a procedure within the scope of the present invention. As shown in FIG. 7A, an end swivel bracket 106 is positioned above the upper end of a stilt 101 with the bracket coupler 200 substantially coaxial with the stilt 101 and the coupler flange 211 closest to the stilt 101. Likewise. FIG. 7B shows a mid swivel bracket 107 being installed on a stilt 101, with the bracket 107 positioned above the upper end of the stilt and the bracket coupler 200 aligned with a solar module array 100 so that coupler flange 211 is closest to the stilt. In FIGS. 7C and 7D, the swivel brackets 105 are installed on the stilts 101 in a manner applicable to both end swivel brackets 106 and mid swivel brackets 107. In FIG. 7C, a stilt crimp 250 has been formed just below the upper end of the stilt 101 and substantially aligned with a coupler grip section 212 (FIG. 6) that is now inside the stilt 101. In FIG. 7D, the swivel bracket 105 is rotated around the bracket coupler aperture 204 relative to the stilt 101, demonstrating how the swivel bracket 105 may vary in angle relative to the stilt 101 so that the solar module array can be mounted in a manner that follows the shape of the terrain or any other desired contour. This installation process can be applied to an extended mid swivel bracket 124, a crest span bracket, a universal swivel bracket, or any other swivel bracket configurations.

FIG. 8 shows top-down views of several crimp patterns 250A through 250H. While the cross section of the stilt prior to crimping may be circular 251, the cross section of the crimp once formed may be triangular, square, rectangular, pentagonal, hexagonal, or otherwise polygonal, or circular or oval-shaped. The lengths of the side walls of any single crimp pattern may be substantially equal or may differ. A plurality of stilt crimps may be formed on a single stilt 101, such as depicted in FIGS. 6C and 6D. A stilt crimp may be configured to compress the coupler grip section 212 to a degree sufficient to prevent the coupler flange 211 from rising above the crimp, as may occur due to upwards wind pressure. A plurality of stilt crimps may be formed on the stilt, each crimp compressing the coupler grip section for enhanced safety during a high loading event such as a hurricane. An individual stilt crimp or a series of stilt crimps may be configured to prevent the bracket coupler 200 from dislodging from the stilt when the coupler is subjected to a load of 1000 to 2200 pounds-force, for example, imposed upwardly on the bracket coupler 200. Stilt crimps may be formed by use of a hand-operable mechanical, electric, or hydraulic crimping tool, and by a machine powered pneumatic, hydraulic, mechanical, or electric crimping tool, or by any other means. Two or more of the various stilt crimp patterns 250A-H may be used on the same stilt 101, or the crimp patterns on a given stilt may all be of the same pattern with the pattern rotating around the axis of the stilt. For example, a single stilt may have a first crimp with the cross section 250A, and a second crimp may have the same cross section but rotated 180 degrees relative to the first.

FIG. 9 is a side view of a solar module array 100 with a first row of stilts on the right and a second row of stilts on the left, installed at various heights above a terrain 110. These two rows may support a north- or south-most row of solar modules.

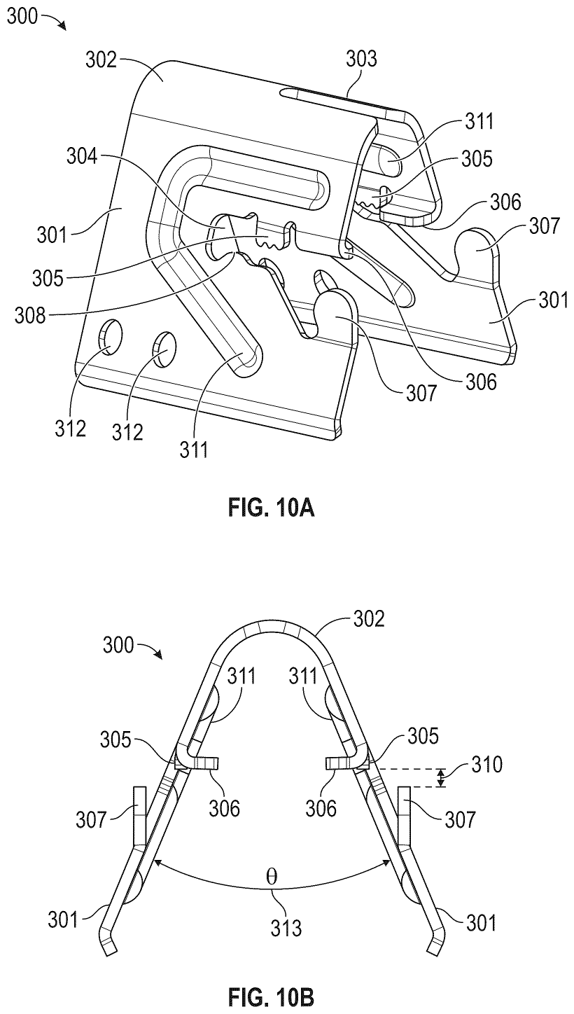

FIGS. 10A and 10B are isometric and end views, respectively, of a module clip 300 used to secure a solar module to a swivel bracket. The module clip may have a first side wall 301 and a second side wall 301 connected by a hem 302 and forming an angle 313 when the clip is in an uncompressed state. As used herein, the term “hem” designates a web joining the two side walls of the clip, in the form of an elongated dome at the top of the clip. In some example embodiments, the first and second side walls are symmetrical, or mirror-images of each other, relative to a mid-plane of the hem 302. Module flange apertures 304 may be located midway down the side walls from the hem 302. One or more bonding features 305 may extend down from an upper edge of a module flange aperture 304, each feature containing one or more sharp points to pierce the coating on a solar module frame and thereby create an electrical bond path. The solar module 104 may have an aluminum or steel frame with a coating formed by anodization, paint, powder coating, or any other known coating method. As depicted, the bonding feature 305 may extend down at an angle relative to the side wall 301 such that it will be vertical, or it may be coplanar with at an angle to the side wall. One or more module compression flanges 306 may extend inward, as depicted, or outwards from the side wall in a horizontal plane, or at an angle slightly less than horizontal when the module clip 300 is in an uncompressed state. As an example for illustrative purposes only, if the uncompressed angle 313 is 60 degrees, the angle formed between side wall 301 and module compression flange 306 may be 60 degrees. As another example, the angle 313 may be 65 degrees. The module compression flange 306 may be configured to deflect before yielding in order to impart a compressive force on a to-be-installed frame flange. The gap between the bonding feature 305 and the module compression flange 306 may be equal to or larger than the thickness of the module clip material. The module contact flange 308 may protrude into the module flange aperture 304 to coincide with the frame of a solar module. The module flange aperture 304 may have enlarged radius at one end with surfaces that are shaped or textured to prevent tearing or ripping of the side wall 301 when an upward force is imposed on the module compression flange 306 and a downward force is imposed on the swivel grip 307, such as when a force is applied in a direction orthogonal to the surface of the solar module. A module flange aperture 304 and a hem cut 303 may extend similar distances into the module clip 300 so that when a compressive force is applied to one or more retention apertures 312 on both side walls 301, the side walls deflect inwardly in a relative planar motion to minimize twisting.

One or more ribs 311 may be disposed on the side walls 301, each rib having a lower end protruding inwards towards the opposing side wall as depicted, or protruding outwards away from the opposing side wall 301. The ribs 311 may be configured to increase the moment of inertia of the side wall along the bend axis of the hem 302 in order to reduce the deflection of the side wall 301 along an X, Y, or Z axis. One or more retention apertures 312 may be disposed on each side wall 301, each aperture configured to receive a flange on an installation tool, as described below. The retention apertures 312 may be circular, oblong, slotted, rectangular, square, oval-shaped, rectangular with a full radius at either end, or any other suitable shape.

One or more swivel grips 307 may protrude upwards from a lower segment of a side wall 301 towards or into a module flange aperture 304. A swivel grip 307 may have a curved upper edge as shown, such as an edge with a circular or oval-shaped contour. The main body of the swivel grip 307 may be planar with the side wall or angled relative to the side wall, as depicted, in a substantially vertical position when the module clip is uncompressed, as shown in FIG. 10B. The curved upper surface of the swivel grip 307 may be configured to pivotally cooperate with the interior surface of the hollow hem 203. A swivel grip 307 may be referred to as a tab.

The module clip 300 may have a substantially uniform wall thickness, manufactured from a material of uniform thickness such as sheet metal. The material may be steel, stainless steel, aluminum, iron, polymer, or any other suitable material. The module clip may be formed into its final desired shape from an alloy steel and then heat treated to increase the yield strength of the material. The material of the module clip may be configured to allow the module clip to flex about the hem 302 from an uncompressed angle 313 to a compressed angle, of for example less than 5 degrees, in which the first and second side walls are nearly coincident. In other words, the module clip may be configured to flex within a range of zero to 90 degrees or greater without permanently deforming.

The module clip 300 may be configured with a gap 310 measured from the distal end the of swivel grip 307 to the closest point on the module compression flange 306 or to the tip of the bonding feature 305. The bonding feature 305 may extend slightly below the lower surface of the module compression flange 306 as viewed in FIG. 10B. The module flange gap 310 may be less than the thickness of a module frame flange plus the thickness of the material of a swivel bracket 105 at the hollow hem 203. As such, the module flange gap 310 can compress the flange of a frame of a solar module 104 onto the hollow hem 203 between the module compression flange 306 and the swivel grip 307.

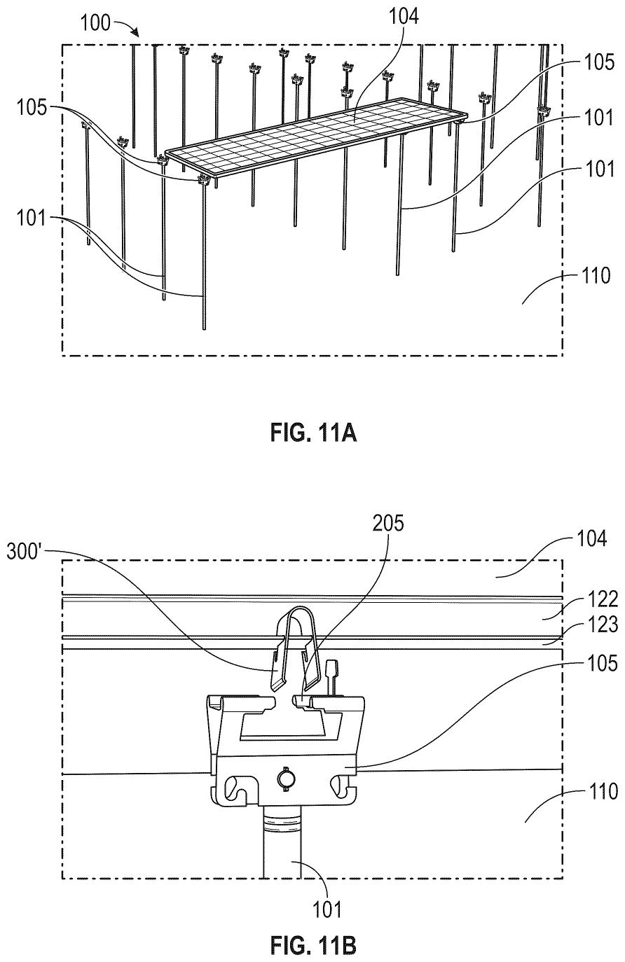

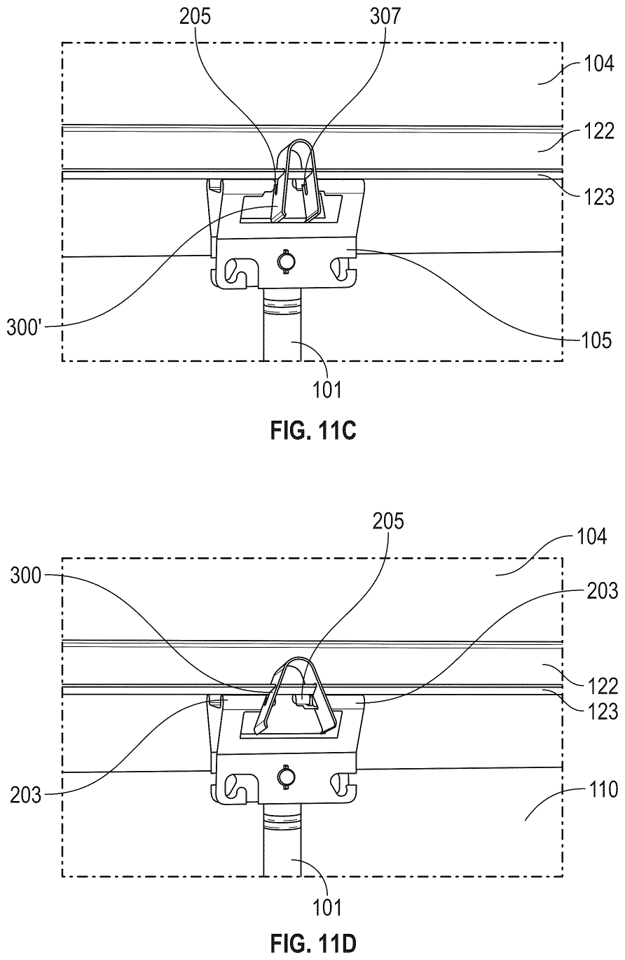

FIGS. 11A through 11D depict a sequence for mounting a solar module 104 to a plurality of swivel brackets 105 using one or more module clips 300. FIG. 11A is an isometric view of a solar module 104 positioned above four swivel brackets 105 on which the module is to be mounted. In this installation procedure, the solar module 104 is in a portrait orientation, but a solar module 104 in a landscape orientation can also be mounted by the same procedure. The step shown embodiment in FIG. 11A may follow the steps shown in FIGS. 1 through 9. FIGS. 11B through 11D are views from underneath the solar module looking out towards the horizon. In FIG. 11B, a module clip is in compressed form and installed onto a flange 123 of a solar module frame. The module clip is compressed so that the distance between the outer surfaces of the first and second side walls is less than the width of the clip aperture 205, thereby allowing the compressed module clip to enter the clip aperture 205. In FIG. 11C, the solar module 104 has been lowered so that the underside of the flange 123 of the module frame abuts or contacts the outer surface of the hollow hem 203. The module clip is then released to an uncompressed state by the spring force of the hem 302, as shown in FIG. 11D. With the module clip in an uncompressed state, one swivel grip 307 can be inserted into one hollow hem 203 and a second swivel grip 307 can be inserted into a second hollow hem 203. Once this occurs, the end of a swivel grip cooperates with the inside surfaces of the hollow hem to compress one or more bonding features 305 and module compression flanges 306 against the top surface of the flange 123 of the module frame, a thus causing the module clip to clamp the frame flange 123 onto the swivel bracket 105. One or more bonding features 305 may also pierce a coating such as an anodized layer on the frame flange 123, creating an electrical bond path from the frame flange 123 to a swivel bracket 105, a stilt 101, and second, third, or fourth solar modules yet to be mounted to a swivel bracket 105.

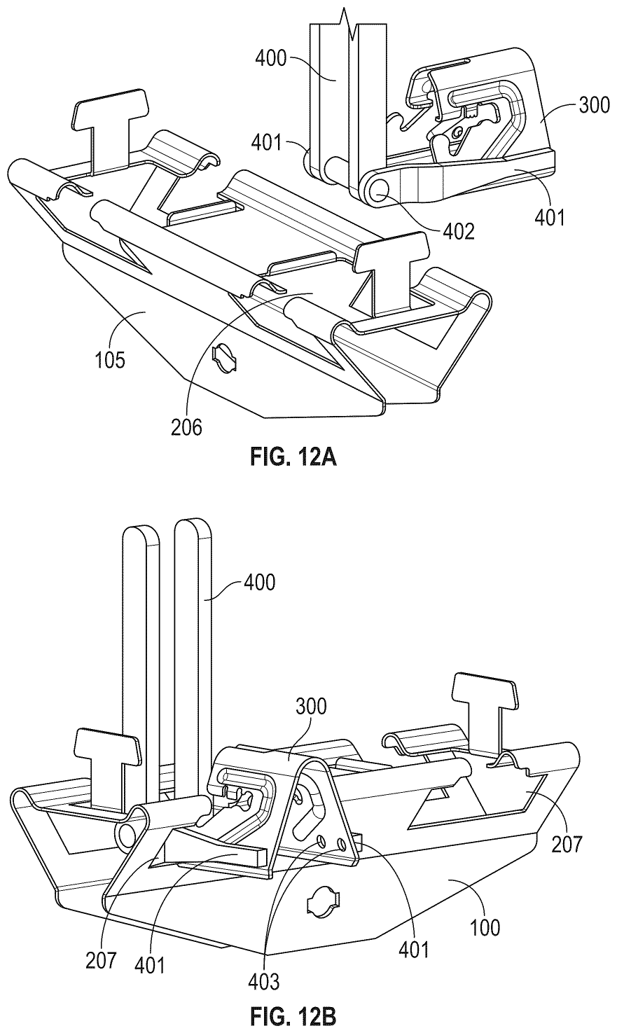

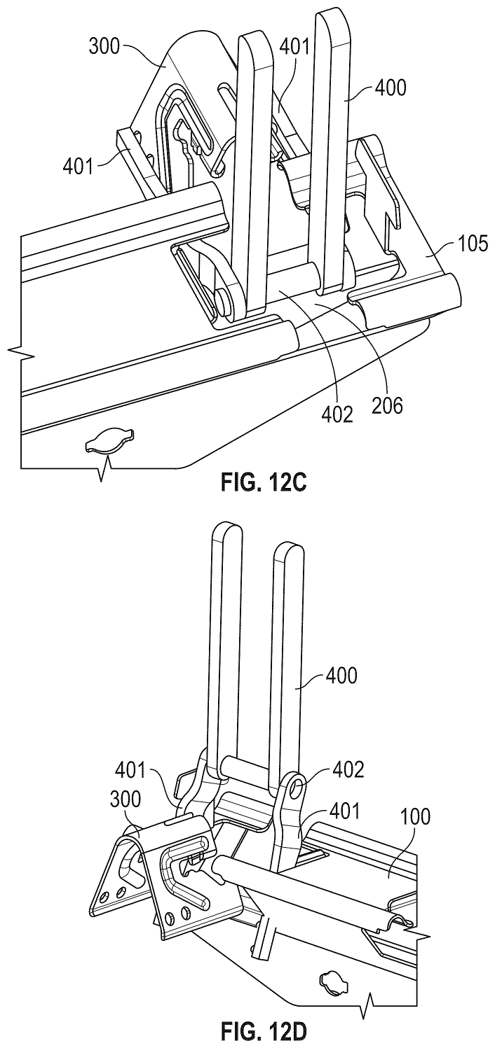

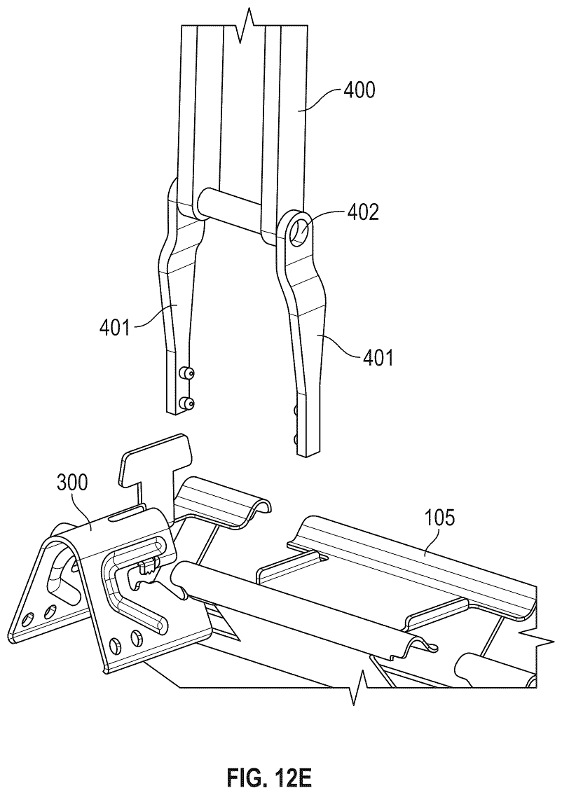

FIGS. 12A through 12E depict an example of an installation apparatus and an illustrative sequence for installing a module clip 300 on a swivel bracket 105, with the solar module and stilt removed for a clearer understanding of the installation. In FIG. 12A, the module clip 300 is held by a clip plier 400 that contains two clip plier arms 401, one gripping each side of the module clip. One or more clip retention flanges 403 (FIG. 12B) may engage with one or more retention apertures 312 (FIG. 10A) on the clip to retain the clip in position relative to the clip plier. The clip plier has one or more clip plier arms 401 (FIG. 12A) attached via a clip plier arm axle 402. The clip plier is configured to transition the module clip from an uncompressed state to a compressed state. The clip plier and top access aperture 206 (FIG. 12C) are configured to allow the clip plier 400 to pass through the top aperture when the module clip 300 is in either a compressed or uncompressed state. FIGS. 12B and 12C are isometric views showing the module clip after the clip has been released from the compressed state and a solar module (not shown) has been placed onto the swivel bracket 105 (such as in FIG. 11D). The clip plier arms 401 are able to extend through the side access apertures 207 (FIG. 11C). FIG. 12D shows the clip plier 400 extending to a greater width to disengage the one or more clip retention flanges 403 from the respective one or more retention apertures 312. FIG. 12D also shows the and clip plier arms 401 pivoting about the clip plier arm axle 402 as the clip plier 400 is lifted up and out of the solar module array 100 through the top access aperture 206. FIG. 12E shows the clip plier 400 fully removed from the swivel bracket 105.

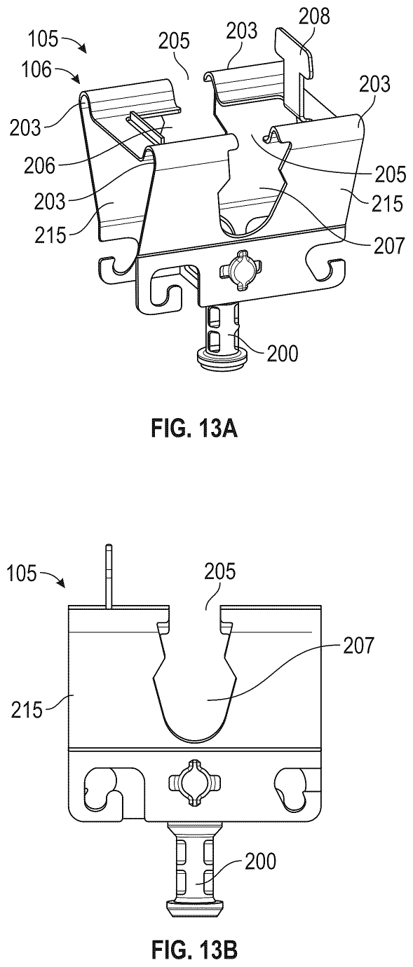

FIGS. 13A and 13B depict an alternative example of the side access aperture 207 on a swivel bracket 105. In this example, the side access aperture 207 has a complex shape to align with a module clip of corresponding configuration.

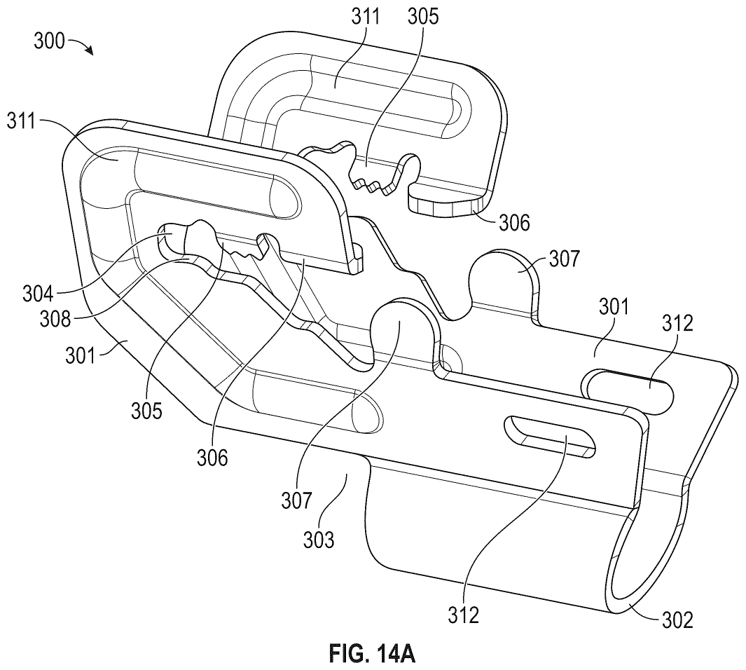

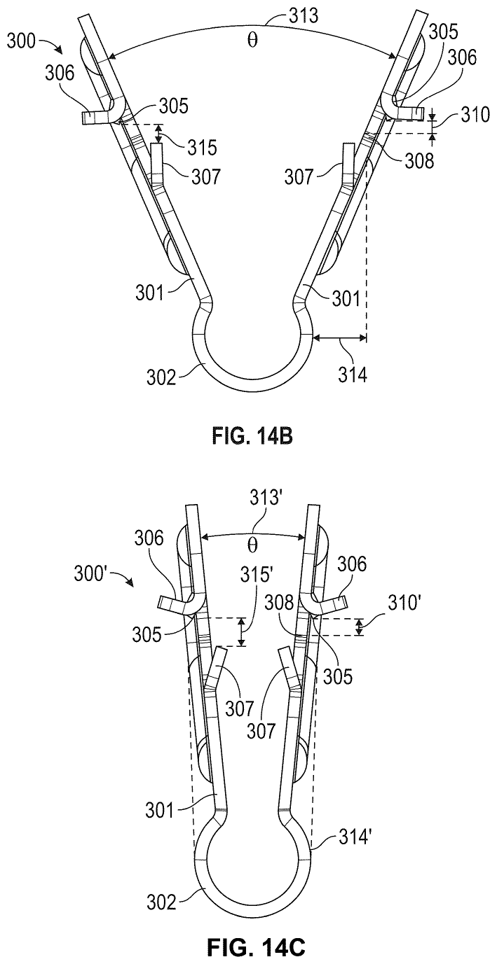

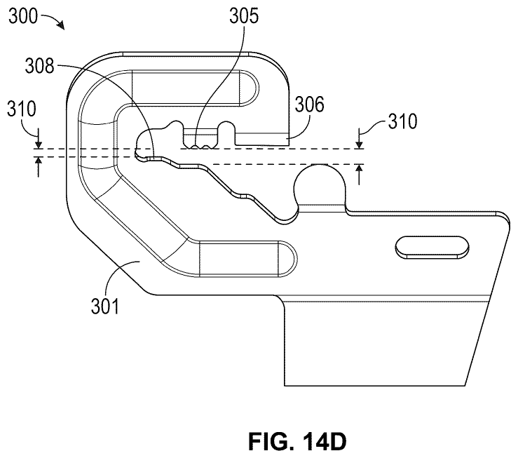

FIGS. 14A through 14D are isometric, end, and side views of an alternative module clip 300 where the hem 302 connects a first side wall 301 to a second side wall 301 below the module flange aperture 304. In this example, the bonding feature 305 is angled towards the centerline of the module clip 300. The hem may extend the full length of the clip or only part of the length. The hem is at one end of the side wall 301 with the module frame aperture 304 at the other end. The hem 302 may have a circular or oval-shaped profile and may form an angle with the side wall. For example, the hem 302 may be curved greater than 180 degrees, preferably the side wall 301 may form an obtuse angle with a line tangent to the hem at the point where the hem meets the side wall.

The retention aperture 312 on the module clip is a horizontal slot in this example, and may be on an end of the module clip 300 opposite to that of the module flange aperture 304. The side wall 301 may extend beyond both the end of the module flange aperture 304 and the swivel grip 307, with the retention aperture 312 being beyond both the swivel grip 307 and the module flange aperture 304.

FIGS. 14B and 14C depict a module clip in an uncompressed state forming an uncompressed angle 313 and in a compressed state forming a compressed angle 313′. The module flange gap 310, whose height is measured from the top of the module contact flange 308 to the bottom surface of either the bonding feature 305 or the module compression flange 306, may likewise vary between a relatively small height 310 when the clip is uncompressed to a greater height 310′ when the clip is compressed. The greater height is preferably greater than the thickness of a module frame, and the smaller height is preferably equal to or less than the thickness of the module frame flange 123. The frame-bracket gap 315 has a height measured from the distal end of the swivel grip 307 to the tip of the bonding feature 305 at the underside of the module compression flange 306. As in the module clip 300, the frame-bracket gap 315 in the relaxed clip may be equal to or less than the thickness of the frame flange plus the thickness of the material forming the hollow hem. Likewise, the gap 315′ in the compressed clip may be greater than the thickness of the frame flange 123 plus the thickness of the material of hollow hem 203. The wall-to-hem overhang 314 may be the distance from the outer surface of the hem 302 to the point on the side wall 301 near the module compression flange 306. With the clip compressed, this overhang 314′ may reduce to near-zero. The hem 302 will thus have an outer radius substantially equal to the distance from the centerline of the module clip 300 to the outside edge of the side wall 301 at the module flange aperture 304.

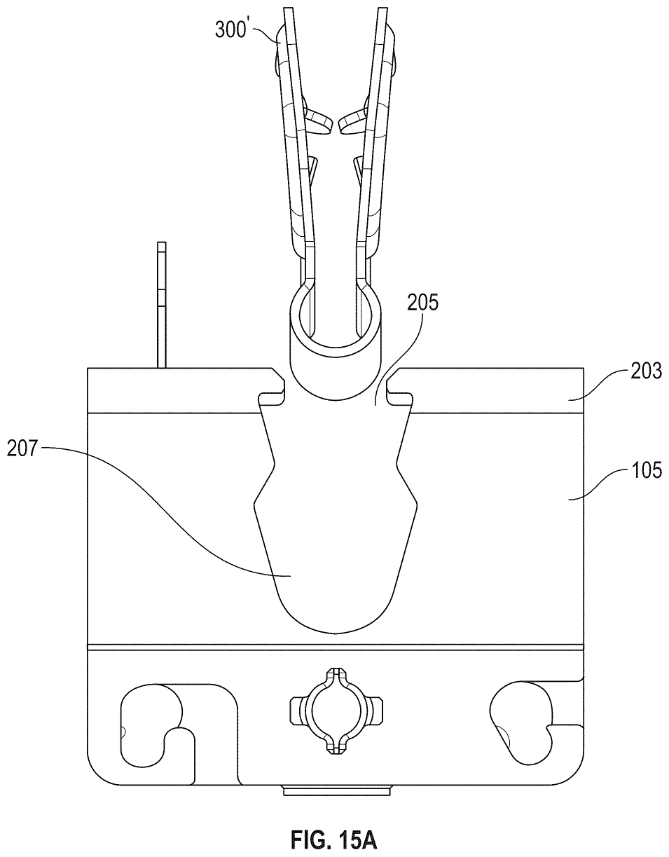

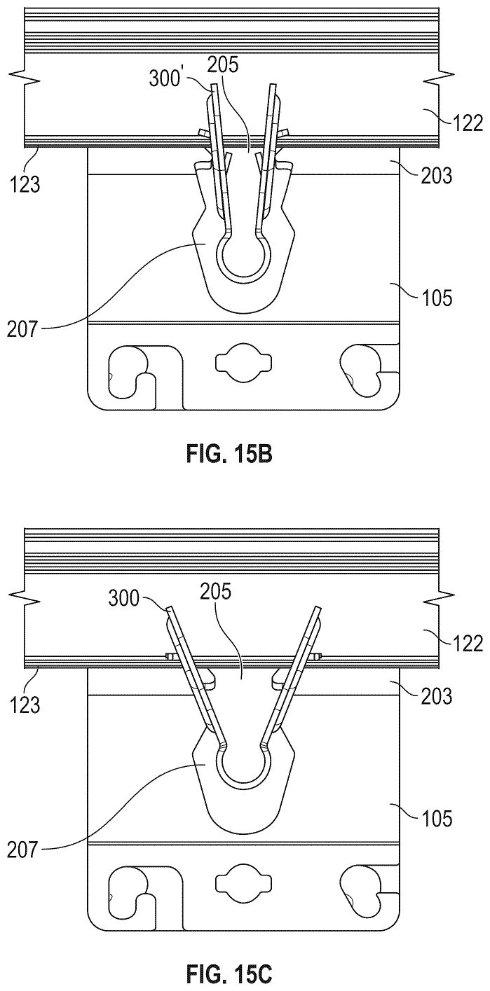

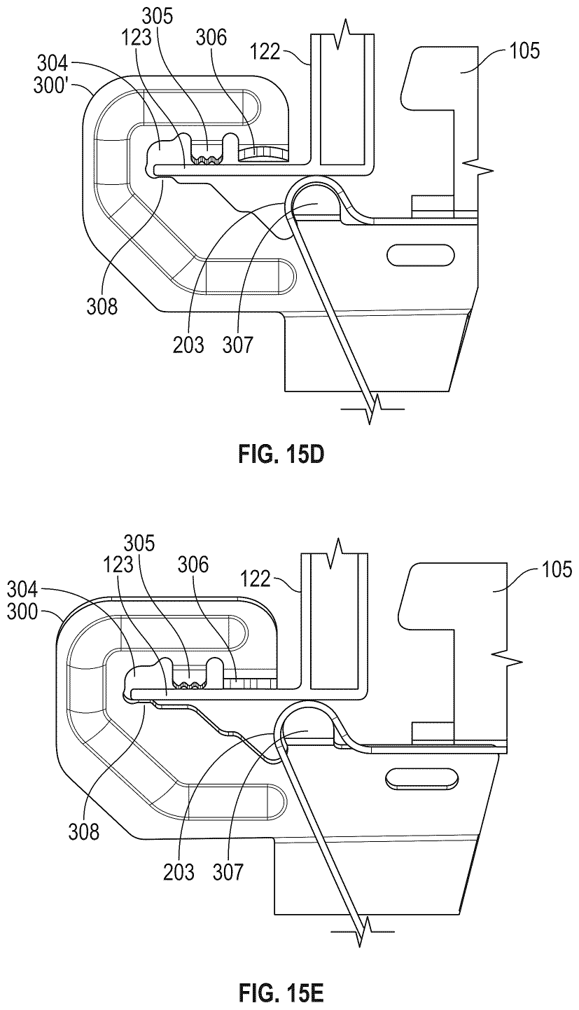

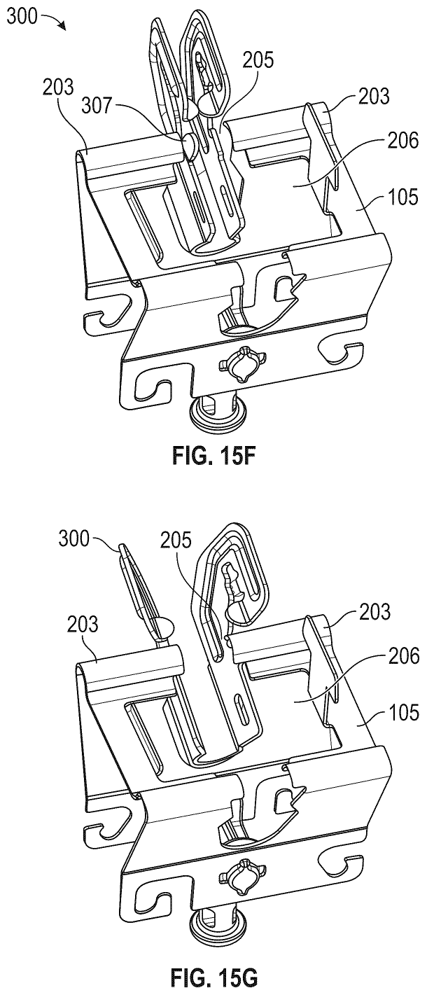

FIGS. 15A through 15G are front, side view and isometric views of a module clip 300 being installed on a swivel bracket 105 with the solar module removed in some cases for clarity. As depicted in FIG. 15A, the compressed module clip 300′ is poised above the clip aperture 205. The module clip 300 may be secured to the flange 123 on a module frame before compression. The diameter of the hem 302 may be smaller than the clip aperture to allow the compressed module clip to be inserted through the clip aperture and into the side access aperture 207. The module clip when compressed may be inserted into the side access aperture 207 until one or more swivel grips 307 (FIG. 15D) are substantially concentric with one or more hollow hems 203. As shown in FIGS. 15D and 15E, the flange 123 on a module frame may be positioned in the module flange aperture 304 with a bottom surface tangential to the outside surface of the hollow hem 203. The compressed module clip 300′ may be configured so that a gap remains between the swivel grip 307 and an inside surface of the hollow hem 203 and between a top surface of the frame flange 123 and the bonding feature 305 and/or the module compression flange 306. In other words, the clip may be configured such that when it is compressed, it does not substantially clamp the swivel bracket 105 to the solar module frame 122, or it imposes a near-zero clamping force between the compressed module clip, the swivel bracket 105, and the solar module frame 122.

FIGS. 15C and 15E show a module clip 300 in an uncompressed state, inserted in the hem 203 of a swivel bracket 105. The side walls 301 of the clip contact the sloped portions of inner walls of the bracket aperture 207. When a first side wall 301 coincides with a first side aperture edge 225, the distance between a second side wall 301 of the module clip 300 and a second side aperture edge 225 of the swivel 105 may be less than the distance a second swivel grip 307 has traversed into a second hollow hem 203. In this way, if module clip 300 were to traverse laterally along hollow hem 203, a first and second swivel grip 307 would remain captured by a respective first and second hollow hem 203 when a first or second side wall 301 abuts a first or second side aperture edge 225. In other words, swivel grip 307 prevents the lateral movement of the module clip 300 along the swivel bracket 105. As such, a module clip 300 would be fully retained and uninstallable unless transitioned into compressed module clip 300.

Module clip 300 may be configured to actively compress frame flange 123 onto hollow hem 203. The bonding feature 305 and the module compression flange 306 may be configured to press against the top surface of the frame flange 123, and the swivel grip 307 may be configured to press against the inside surface of the hollow hem 203. In effect, the module clip 300 and the swivel bracket 105 may be configured so that module contact flange 308 scores the surface of one end the frame flange 123, while the hollow hem 203 presses upward against the opposite end of the frame flange 123 through the upward compression of the swivel grip 307. At the same time, the bonding feature 305 and/or the module compression flange 306 presses down against the frame flange 123 at mid-span, thereby providing a 3-point bending pattern or configuration on the frame flange 123. The module compression flange 306 may be configured with a flat or rounded surface positioned to contact the frame flange 123 when the module clip 300 is uncompressed, without cutting, gouging, tearing, grinding, sanding, or otherwise weakening the frame flange 123. When fully installed, as depicted in FIGS. 15C and 15E, the module clip 300 may be able to pivot and rotate around the axis of the hollow hem 203.

The module compression flange 306 may be configured so that a cut edge of the material of the module clip 300, such as the cut edge of the side wall 301, is not the primary contact surface to frame flange 123. The module compression flange 306 may have deburred, coined, smoothed, chamfered, radiused, or rounded edges to prevent chafing of or cutting into the surface of the frame flange 123. The bonding feature 305 may have one or more protrusions, spikes, barbs, or sharp points its distal end to pierce the coating on a frame flange 123 and thereby create an electrical bond path between the frame flange 123, module clip 300, and swivel bracket 105.

The module flange aperture 304 (FIGS. 15D and 15E) may be configured so that all of the bent flanges on the module clip 300 are co-planar with the side wall 301 before forming. When the bonding feature 305 and the module compression flange 306 are cut to size before being bent to be non-planar with the side wall 301, the width of the module flange aperture 304 may be at least as great as the thickness of the module clip material. For example, before the flanges are being bent or formed but after they are cut to size, the distance between the contacts end of the bonding feature 305 and the module compression flange 306 and an opposing face of the module flange aperture 304 may be at least as great as the thickness of the module clip material.

The solar module may be 1500 to 2500 millimeters long. 700 to 1500 millimeters wide, and 25 to 42 millimeters tall. The Frame flange 123 on the solar module frame may be 1.4 to 2.4 mm thick, and the module clip 300 may be configured to engage with a flange of these dimensions. The solar module shown has a frame 122, but a solar module without a frame can also be used. Such a module may instead be constructed of two sheets of glass encapsulating solar photovoltaic materials. For such a module, the module clip 300 may be configured so that module compression flange 306 engages the first glass sheet, while the second glass sheet contacts the outside surface of the hollow hem 203. For this frameless module, the bonding feature 305 may be removed, and a soft material such as a rubber pad may be used instead on the surface of the module compression flange 306 that contacts the first glass sheet. The module flange aperture 304 may be configured to accommodate the thickness of such a frameless solar module 104. The first glass sheet may be 1.0-2.5 millimeters thick, and the second glass sheet may also be 1.0 to 2.5 millimeters thick, with the module having a total thickness of 2.0 to 6.0 millimeters thick. The module clip can also be used on a frameless solar module that has a glass sheet on top and a polymer sheet on the bottom as the back surface. One or more structural beams, such as steel or aluminum beams, may be secured to the back surface to provide structural rigidity to the solar module. The module clip may thus be configured to contact the first glass sheet, while the outside surface of the hollow hem 203 contacts either the polymer sheet or the structural beam.

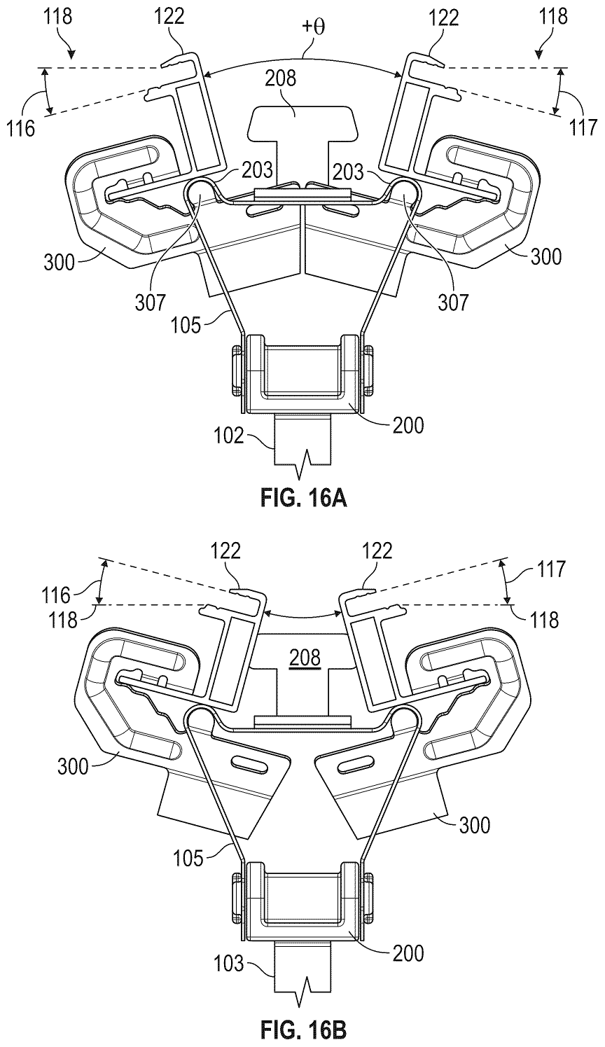

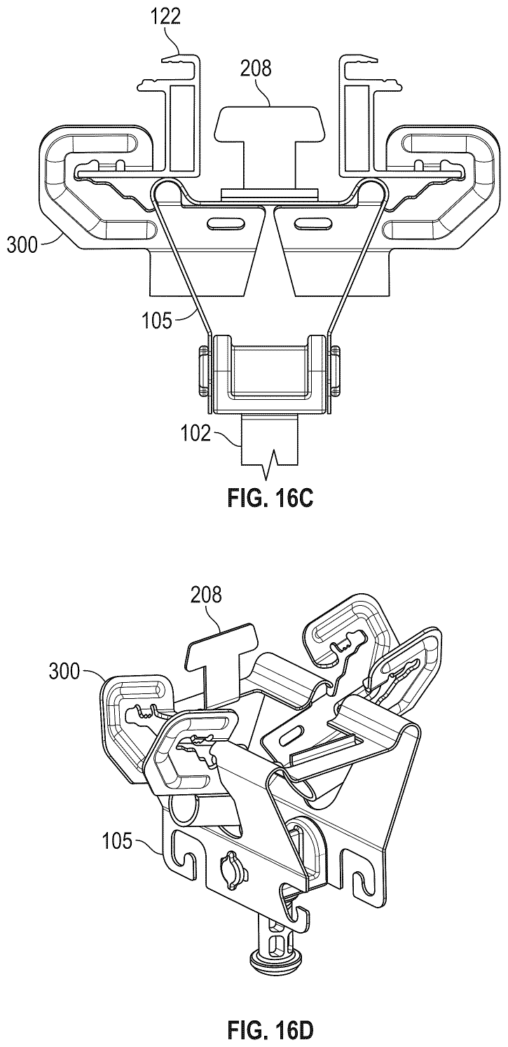

FIGS. 16A through 16D are end and isometric views of two module clips 300 installed on a swivel bracket 105, each clip securing or clamping and potentially electrically bonding a solar module frame 122 to the swivel bracket 105. In these Figures, all components of the solar module other than the frame are removed so that the frame and module clip can be more easily understood. In FIG. 16A, a swivel bracket 105 may be mounted to a long stilt 102, which may cause one or more solar modules to angle away from the swivel bracket. In this configuration, the West module tilt angle 116 and/or the East module tilt angle 117 may be negative angles, such as up to a negative 20 degrees. The swivel grip 307 and the hollow hem 203 may be configured to provide a clamping force that is substantially similar to that between the solar module frame and the swivel bracket over a range of tilt angles 116, 117, such as from negative 20 to positive 20 degrees relative to the horizon 118 or the terrain 110.

FIG. 16B depicts the same view as FIG. 16A, except that the stilt is a short stilt 103, resulting in a West module tilt angle 116 and an East module tilt angle 117 that are both positive angles relative to the horizon. In this configuration, the solar module frame 122 may abut the module spacer 208, the spacer 208 may be configured to provide a desired spacing between the frame of a first solar module and the frame of a second solar module. As depicted, the side edges of the spacer may set a maximum allowable West module tilt angle 116 or an East module tilt angle 117 when the sides of the solar module frames abut the sides of the spacer. FIG. 16C depicts the same view as FIG. 16A, with both the West module tilt angle 116 and the East module tilt angle 117 at zero degrees. The West and East module tilt angles may be substantially equal in value on a given swivel bracket or different. In some cases, the West module tilt angle 116 may be a negative value while the East module tilt angle 117 is a positive value, and vice versa. FIG. 16D is an isometric view of FIG. 16B to provide more clarity.

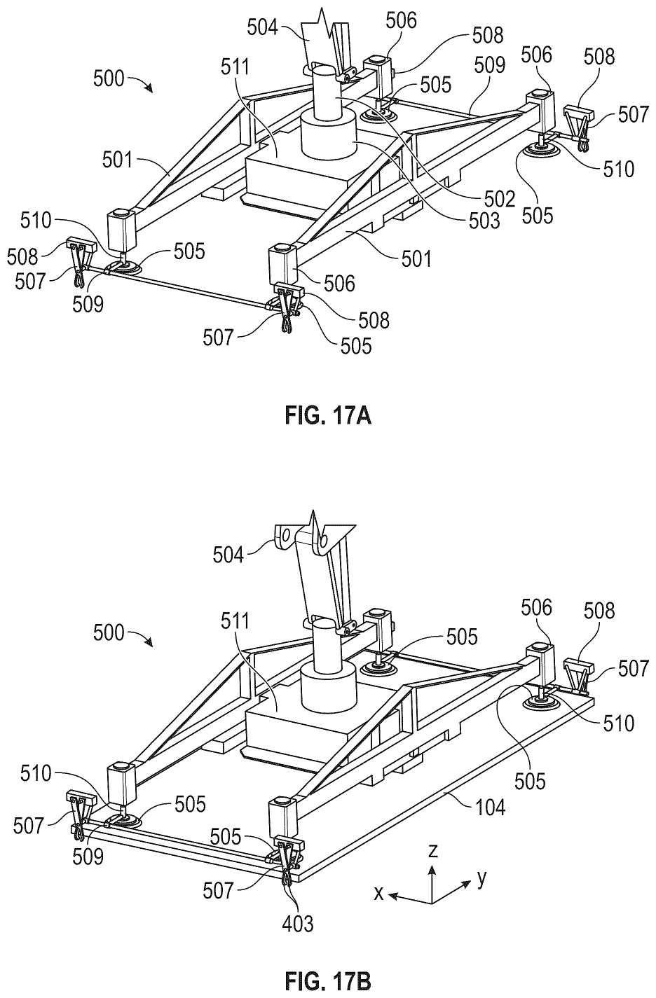

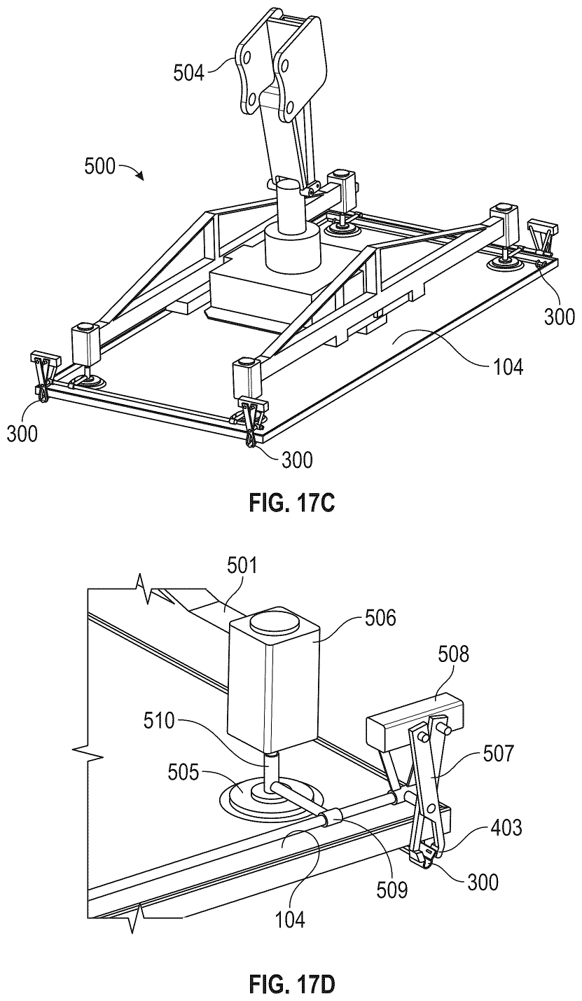

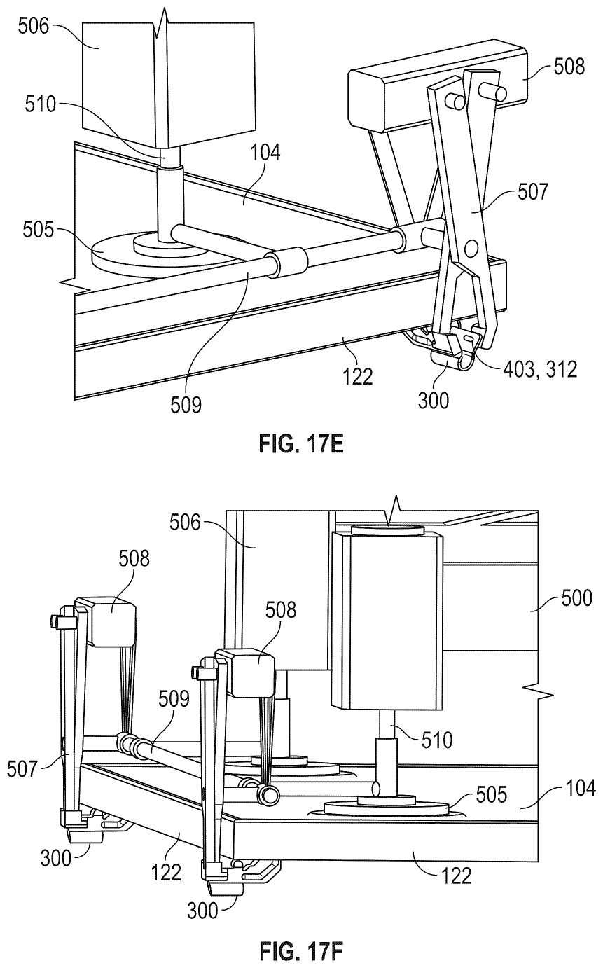

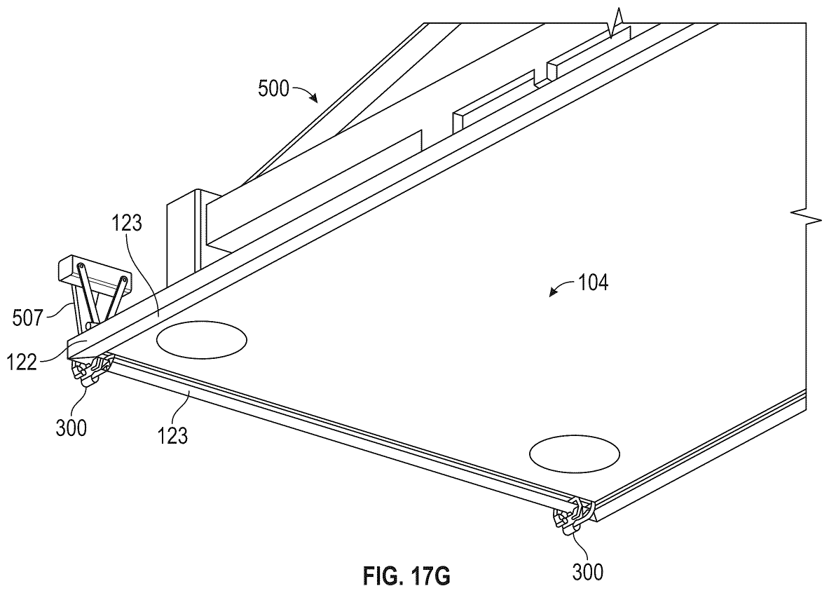

FIGS. 17A through 17F are various views of a module lifter 500 for mounting a solar module and module clip to one or more installed swivel brackets to create a solar module array.

FIG. 17A is an isometric view of a module lifter 500 ready for use. The module lifter 500 may have one or more lifter support arms 501 extending parallel to and away from a main body 511. A lifter attachment linkage 504 may have one end configured to connect with a piece of construction equipment such as an excavator, bulldozer, crane, loader, lifter, or specialty equipment. A second end of the lifter attachment linkage 504 may be joined to a lifter actuator 502, which is configured to move the lifter 500 towards and away from the linkage 504 by precise distances such as less than one inch. The lifter actuator 502 may be a hydraulic ram, an electronic actuator, a mechanical rack and pin, a pneumatic device, or any other suitable mechanism. A lifter rotator 503 may connect the lifter actuator 502 to the main body 511 to rotate the lifter about the primary axis of the actuator. The rotator may be an electronic, hydraulic, pneumatic, mechanical, or magnetic device, or any similar device that can produce rotation. Alternatively, the rotator may be positioned between the actuator and the linkage 504, with the actuator 502 connected directly to the main body 511. The main body 511 may contain electronic control equipment, or a pneumatic or hydraulic pump configured to power or operate a module actuator 506, suction cups 505, a clip compression actuator 508, or a combination of these components.

One or more module actuators 506 may be positioned near the ends of the lifter support arms 501. Four module actuators 506 are shown, one positioned at each of the four ends of the two lifter support arms 501. The lifter support arms 501 may be of telescoping construction to adjust the position of the module actuators 506 relative to each other or to the main body 511. Alternatively, the module actuator 506 may slide along the length of a lifter support arm 501 by way of a track, an aperture, a sleeve, or any similar device, while allowing the module actuator 506 to be releasably locked into a desired position along the lifter support arm.

One or more module actuator pistons 510 may extend from each module actuator 506, each piston having a suction cup 505 at its lower end. The suction cups 505 may have apertures on their undersides to vent or add air or gas and thereby create a suction force against a substantially flat surface, such as the top surface of a solar module. The suction cups may be configured to apply a vacuum necessary to hold up to 200 pounds force and may be made of a pliable material such as a rubber to minimize or eliminate any micro-cracking of the solar cells laminated within the solar module. A clip compression apparatus 509 may be connected to a single module actuator piston 510, or to two module actuator pistons, as depicted. The clip compression apparatus 509 may be connected to both the module actuator piston and the suction cup so that the clip compression apparatus 509 moves up and down with the suction cup when the module actuator piston 510 is retracted from or advanced into of the module actuator 506.

One or more clip compression devices 507 may be connected to a clip compression apparatus 509 in a manner allowing the compression device to slide along the length of clip compression apparatus 509, thereby moving the compression devices toward or away from each other. A clip compression device 507 may be lockable into a desired position along the clip compression apparatus 509 such that when a module clip 300 is engaged to one or more clip retention flanges 403, that module clip 300 may align with a clip aperture 205 on an installed swivel bracket 105 (not shown). When a module clip is mounted to a clip compression device 507 so that one or more clip retention flanges are engaged with respective retention apertures, the clip compression actuator 508 may be connected to the clip compression device 507 in a manner allowing the module clip to transition from an uncompressed state to a compressed state.

FIG. 17B shows the module lifter 500 with a solar module 104 supported by a plurality of suction cups 505. The securement of a solar module 104 to a module lifter 500 may be the first step in adding a solar module 104 to a solar module array. The suction cups 505 use vacuum pressure (suction) to secure the solar module 104 into position by pumping air from the space between each suction cup 505 and the solar module. The solar module is thereby secured in a position relative to the module lifter 500. Although not shown, a plurality of guides may be positioned on one or more sides of the module lifter 500, each guide extending along the side edge of a frame flange 123. These guides can help align the solar module with a swivel bracket. The guides may be positioned along only three edges of a solar module or at two corners of a solar module. The guides may be sloped or chamfered so that when a module lifter 500 is poised above the solar module, such as within 25 millimeters of two of the side edges of the module, the lifter actuator 502 can be extended in length until one or more suction cups 505 make contact with the solar module. While the actuator is being extended, the guides will precisely position the module lifter 500 over the solar module 104, to within 5 millimeters or less of two of the side edges of the module. The guides may be made from a soft material such as a polymer that will protect the solar module from damage.

As shown in FIG. 17B, the solar module 104 is positioned with its center along the vertical axis of the module lifter 500. Clip compression devices 507 are positioned outside the periphery of the solar module frame so that one or more clip retention flanges 403 (FIG. 12B) are below the top surface of the solar module 104. The clip compression devices 507 may be laterally positioned and locked after the solar module is secured to the module lifter 500 (by the plurality of suction cups 505), so that each clip compression device 507 is at a pre-selected distance from the edge of the solar module. The distance may be substantially the same distance as that between the centerline of the clip aperture 205 (FIGS. 14A and 14B) and the centerline of the swivel bracket 105 (FIGS. 16A and 16B).

FIG. 17C illustrates the next step in the installation procedure, in which one or more module clips 300 are positioned into clip compression devices 507 so that the frame flange 123 is within the module flange aperture 304 (FIG. 14A). For this step, a module clip may be in an uncompressed state.

FIG. 17D through 17F are isometric close-up views of a solar module 104 joined to a module lifter with at least one module clip 300 in position.

FIG. 17G is an underside view of a solar module 104 secured to a module lifter 500, with a module clip 300 positioned over a frame flange 123.

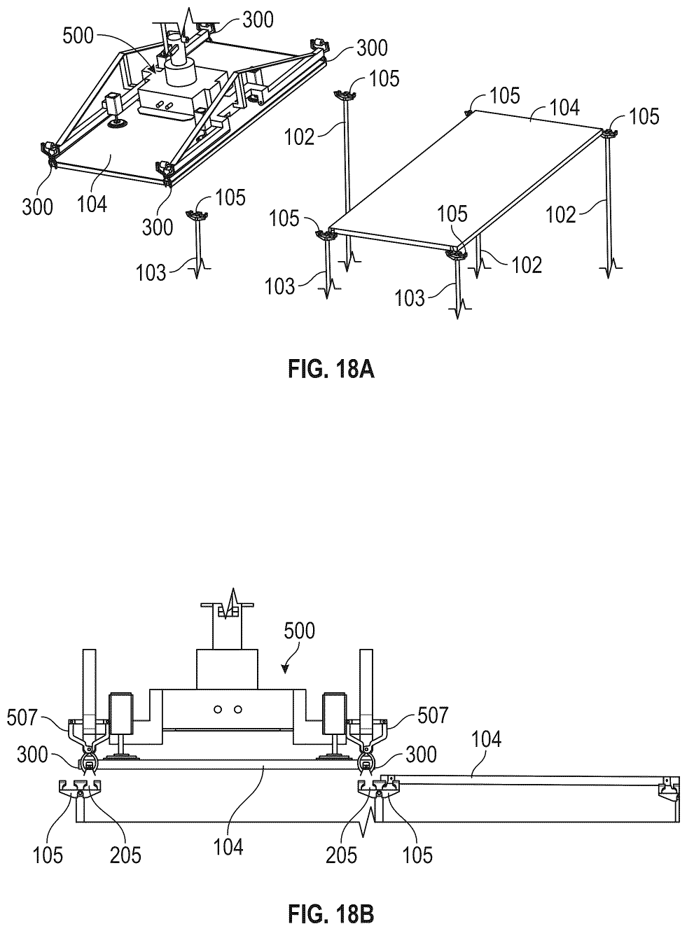

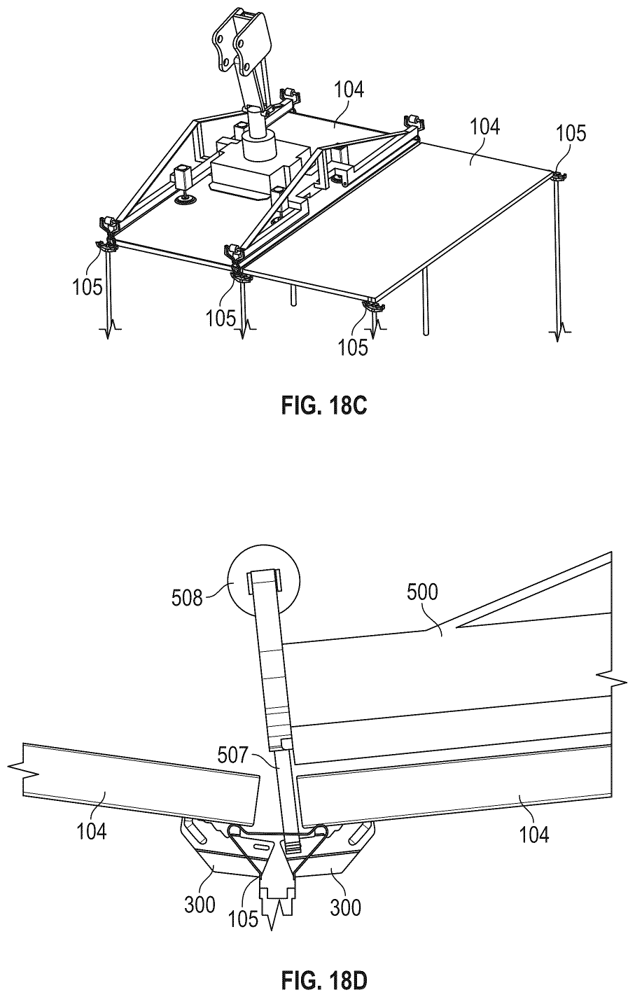

FIG. 18A through 18D are isometric, end, and side views of a solar module 104 being mounted to a plurality of swivel brackets 105 using a module lifter. In FIG. 18A, one solar module, shown at the right, has already been mounted to four swivel brackets 105, and a second solar module, shown at the left, is mounted to the module lifter. The next step is shown in FIG. 18B, in which the centerline of one module clip, shown in the center of the Figure and either compressed or uncompressed, is poised above and substantially aligned with the centerline of a vacant clip aperture 205 on a swivel bracket 105, another clip aperture of which having been already occupied by a module clip. A third module clip is aligned with a clip aperture on another swivel bracket, shown on the left.

As described above, either clip compression device 507 can be adjusted laterally to align with a clip aperture 205 on a swivel bracket 105. A clip compression device 507 can thus be adjusted laterally along the width of the module lifter to align with a solar module prior to installation of the module, and with a set of swivel brackets 105 prior to installation of the brackets.

FIG. 18C is an isometric view of two solar modules 104 mounted adjacent to each other to a plurality of swivel brackets 105. The two solar modules may be substantially co-planar, and one of the modules may be electrically bonded to the other through connection points on one or more module clips 300 and swivel brackets 105.

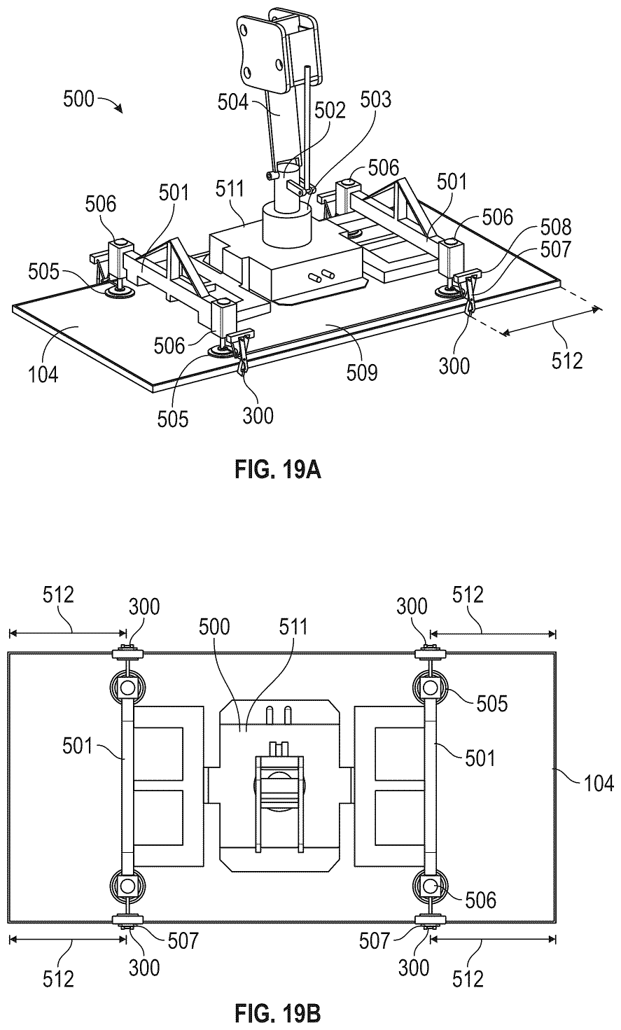

In any of the assembly methods described above in conjunction with FIGS. 17A through 18B, the solar modules can be mounted in either a portrait (as depicted) or a landscape orientation. As shown in FIGS. 19, 24 and 26, module clips 300 may be positioned at points along the long edge of a solar module 104, at distances from the corners of the module, such as 10-35%, or 200 to 800 millimeters down the long edge as measured from the short edge. As shown in FIGS. 19A and 19B, the lifter support arms 501 may be oriented perpendicular to the long sides of solar module 104, with the clip compression devices 507 positioned along the length of the lifter support arms 501. The clip compression devices 507 may be positioned at locations offset from the short edges of the solar module, such as by of 10-40%, or 200 to 800 millimeters, from the short edges.

The lifter actuator 502, lifter rotator 503, suction cup 505, module actuator 506, clip compression actuator 508, and module actuator piston 510 may all be controlled remotely by a wireless device. As an example of an installation procedure, an operator may start by securing a solar module 104 to a module lifter 500 by applying a vacuum to one or more suction cups 505. The operator may then rotate the solar module 104 with the lifter rotator 503 so that the module clips align with the clip apertures 205 on a series of pre-installed swivel brackets 105. The operator may then engage the clip compression devices 507 and compress the module clips, either one at a time or synchronously. Once this is done, the operator may lower the module lifter 500 using a lifter actuator 502 to approach the set of pre-installed swivel brackets 105, and then lower the solar module 104 onto the set of swivel brackets 105 by engaging one or more module actuator pistons 510 either one at a time or synchronously. The operator then may disengage the clip compression device 507 to release the compressed module clip to an uncompressed state, thereby mechanically securing and potentially electrically bonding the solar module 104 to the swivel brackets 105. The clip compression device 507 may then be disengaged so that the clip retention flanges 403 are clear from interference with the retention apertures 312. With the solar module thus secured, the vacuum pressure in the suction cups can then be released to disengage the suction cups from the solar module. The actuator pistons 510 can then be retracted up and away from the solar module. The operator may also retract the lifter actuator 502 and position the module lifter 500 to add the next solar module. A set of suction cups 505, module actuator pistons 510, and/or module actuators 506 may all be engaged simultaneously within that set, or they may be engaged independently, or both.

High-contrast markers may be placed on the top surface of the swivel bracket 105 to serve as visual aids to optical sensors on the module lifter 500. The markers and optical sensors can help in navigating, moving, positioning, aligning, orienting, and/or controlling the movement of the module lifter 500 and its attached components or drive units, such as the lifter actuator 502, the lifter rotator 503 and the module actuator 506 as the solar module is being positioned on the swivel brackets. Pressure sensors, limit switches, contact gauges, or other similar devices may also be used on the module lifter 500 or built into the lifter actuator 502 or the module actuator 506 to provide information feedback to a control unit, indicator light, display, logic board, or other input device. The pressure sensors, limit switches, contact gauges, or other similar devices may be used to signal or directly stop the motion of the module lifter 500, the lifter actuator 502, and/or one or more module actuators 506.

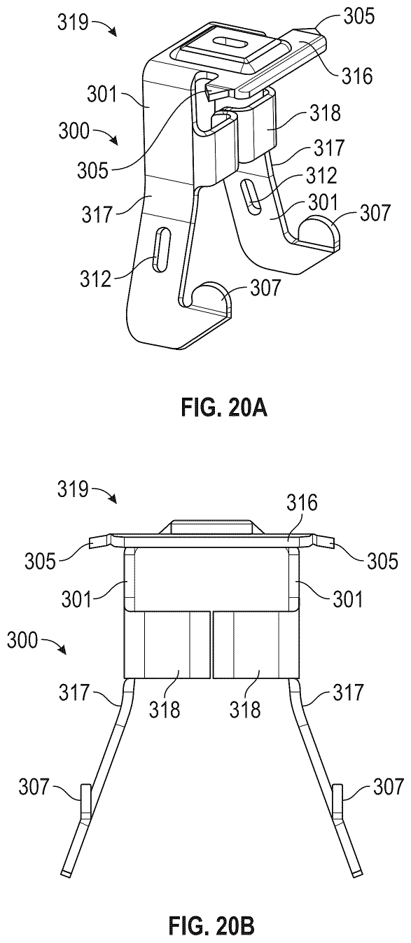

FIGS. 20A and 20B depict an alternative embodiment of a module clip configured as a top-down module clip 319 to clamp a solar module onto a swivel bracket from the top side of a solar module frame. In this embodiment, a clamp flange 316 connects a pair of side walls 301 and protrudes or extends beyond the side edges of the side walls. The clamp flange may extend laterally from the side wall 301 enough to sufficiently contact the top surface of a solar module frame by a distance such as 6-15 millimeters. The side wall 301 may bend outwards partially along its length at a side bend 317. A pair of abutment flanges 318 may be disposed between the side bend 317 and the clamp flange 316, the abutment flanges extending inwards from the side wall 301 and configured to nearly or directly abut one another. One or more retention apertures 312 may be disposed on the surface of each side wall 301, such as on a lower section. One or more bonding features 305 may protrude from the clamp flange 316, the features having and having sharp edges to pierce a coating on the solar module frame to create an electrical bonding path from the solar module frame to the module clip. One or more swivel grips 307 may extend from the lower end of each side wall 301 to engage with the inside surface of the hollow hem 203 (not shown). The lower ends of the side walls 301 beyond the side bend 317 may be angled away from one another, as shown.

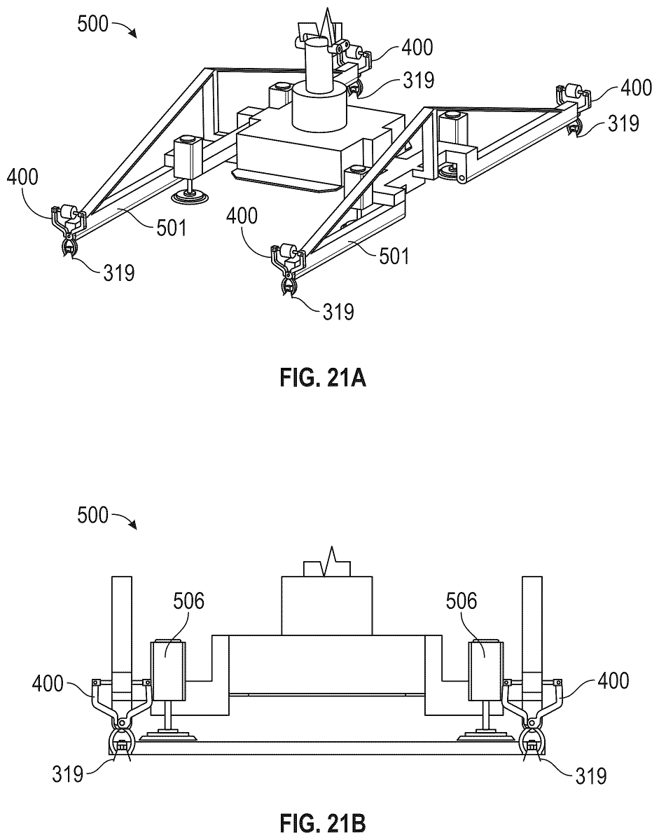

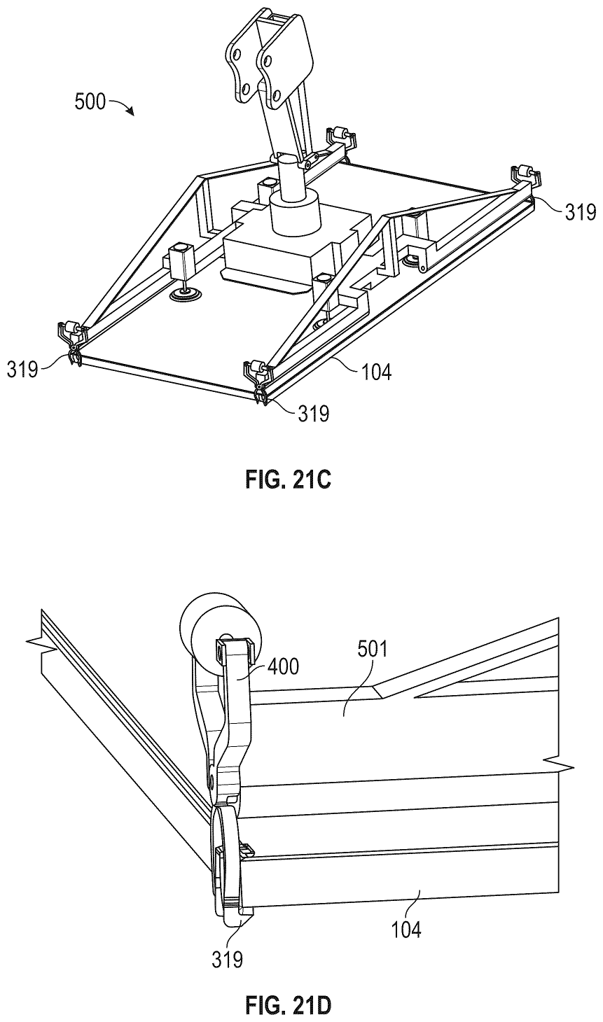

FIGS. 21A through 21D depict a module lifter 500 configured with one or more clip pliers 400 designed to engage top-down module clips 319. The clip pliers 400 are configured to engage the outer surface of the side walls 301 of the top-down module clips 319. One or more engagement features disposed on each clip plier 400 may engage with one or more retention apertures 312 (FIG. 20A) to secure the top-down module clip in place before the clip and a solar module are secured to one or more swivel brackets 105.

FIGS. 22A and 22B are isometric and end views of a corner section of a solar module array 100, with a plurality of swivel brackets 105 engaged with the corner solar module of the array. In a module array such as that shown in FIG. 2, the zone three solar modules 121 may require additional structural support due to exposure to relatively high forces, such as from wind. This additional support may be achieved by an additional short stilt, swivel bracket 105, and end bracket piece between the two stilts near the corners of the module, resulting in three module clips along one edge of the module. The end view of FIG. 22B demonstrates how the three end bracket pieces may be substantially aligned with one another along the axis of the hollow hem 203. FIG. 22C is an isometric view of the module array 100 zoomed out to show the three short stilts and swivel brackets 105 on a zone three solar module 121.

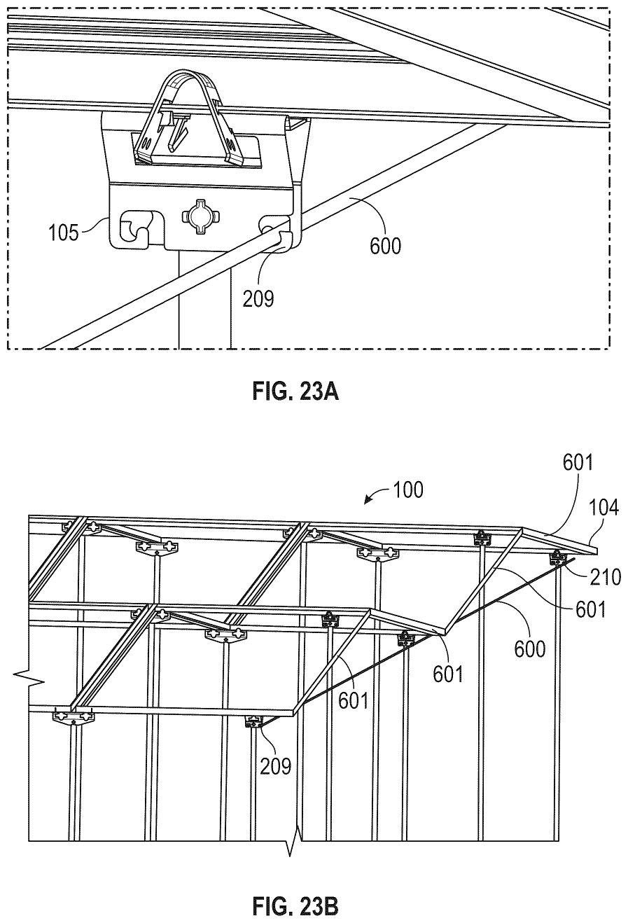

FIGS. 23A and 23B are isometric views of a support cable 600 supported by aligned cable holders, one of which 209 is visible in FIG. 23A, on a swivel bracket 105 in a solar module array 100. In FIG. 23B, a wire 601 extends from the final solar module 104 in each west-facing module column and each east-facing module column. The wire may be supported by the support cable 600 along the length of the solar module array 100 and may be connected to the cable by one or more zip ties, hangers, hooks, trays, cables, loops, or any other devices sufficient to support the weight of the wire. The support cable may be made from coated steel, polymer, aluminum, or other suitable material, and may be a braided cable or rope, a rod, a chain, or a string. Support can also be achieved by a mesh or any other equivalent configuration.

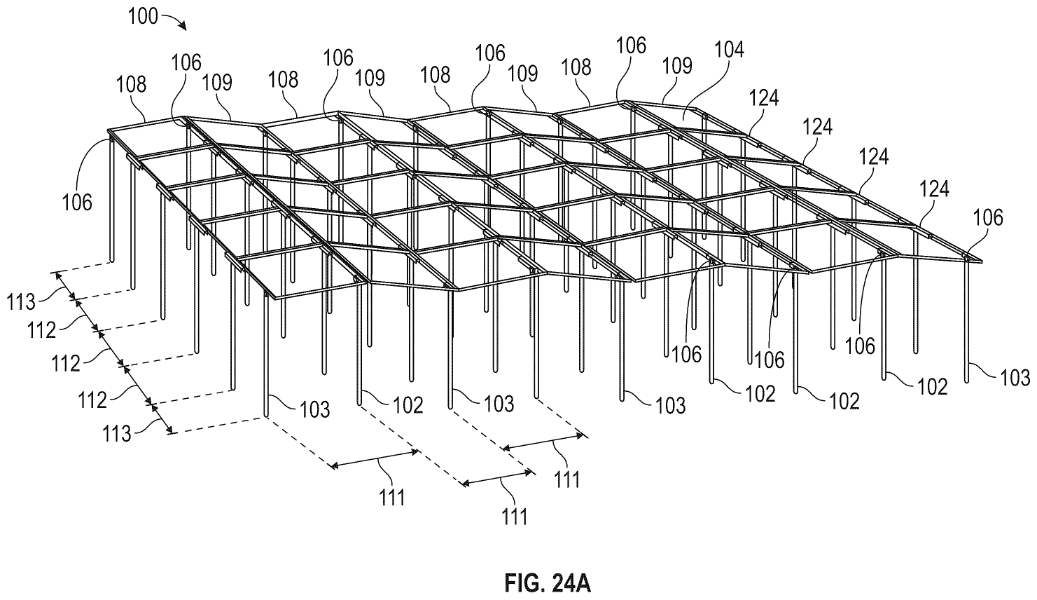

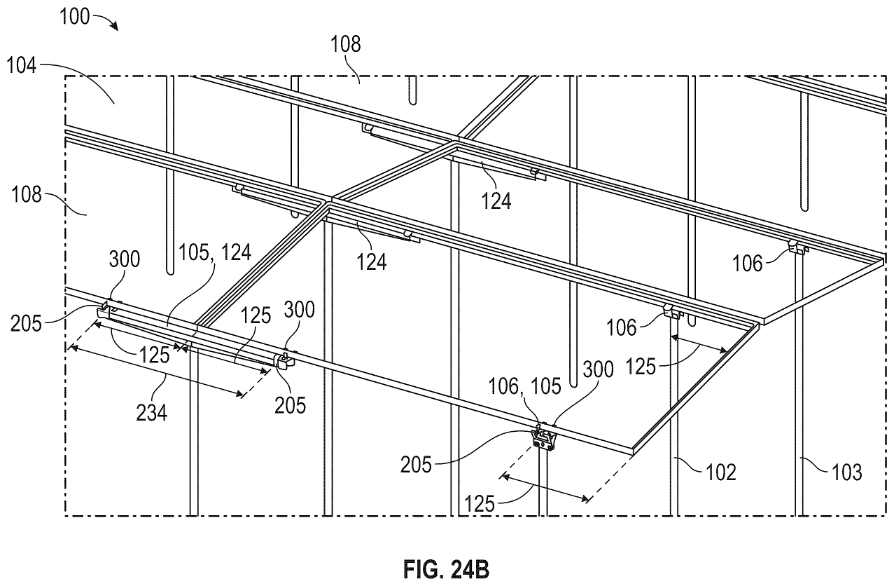

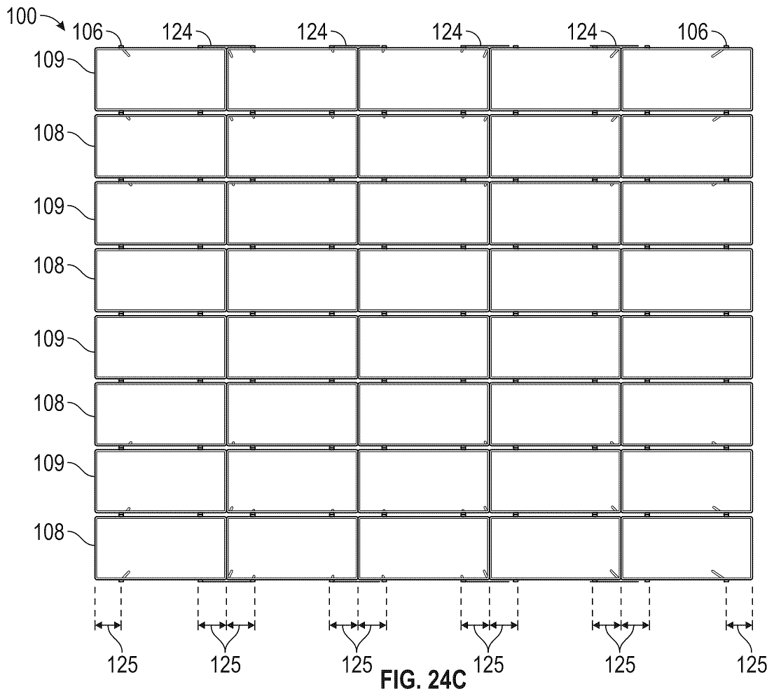

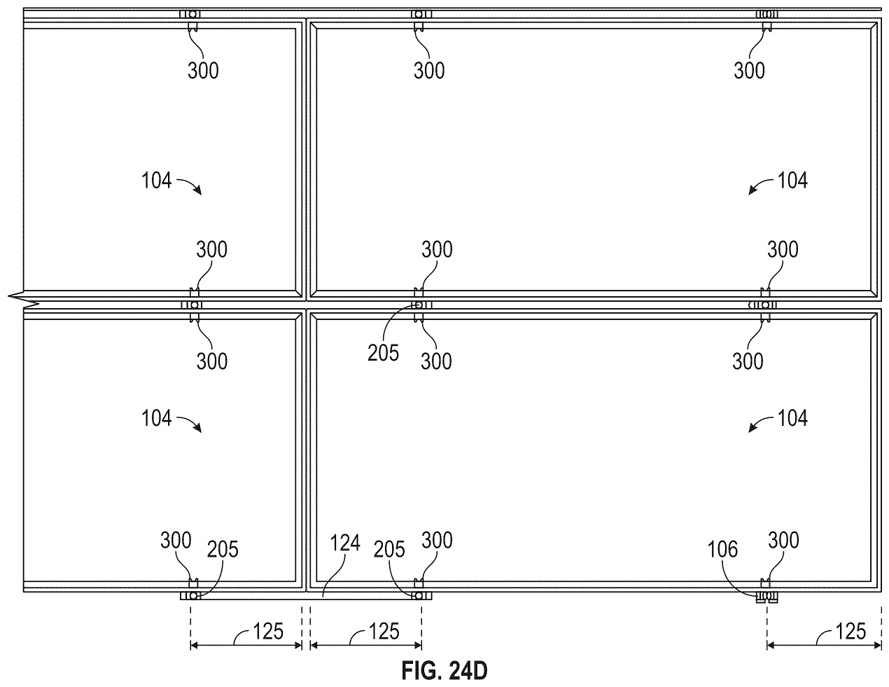

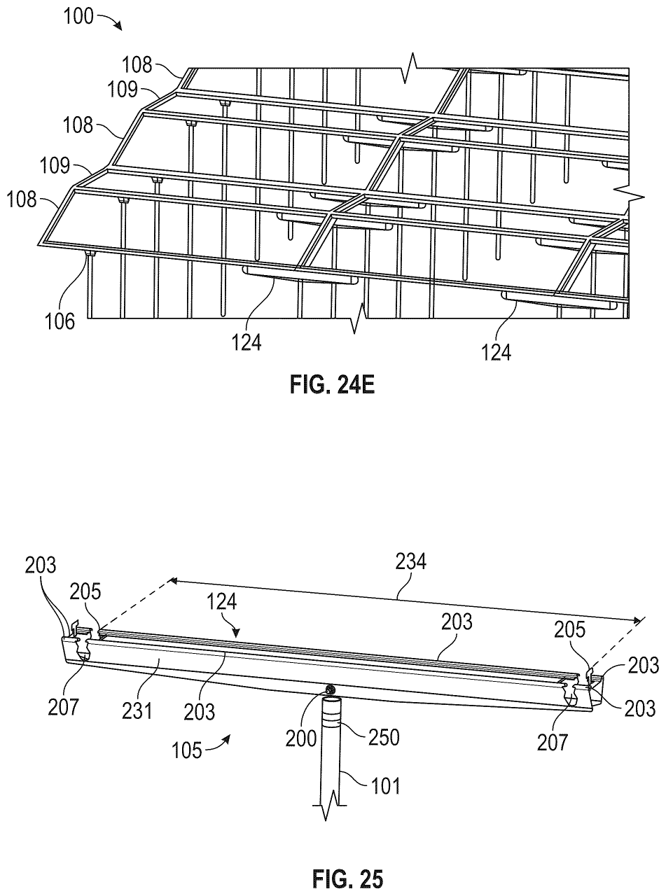

FIGS. 24A through 24E are various views of an alternative solar module array 100 using an extended mid swivel bracket 124 instead of the mid swivel bracket 107 described above, the extended bracket representing another embodiment of the present invention. In the solar module array of FIG. 24A the solar modules 104 (shown as transparent for purposes of clarity) are arranged in a landscape orientation where the long edges of the solar modules are generally parallel to the North-South axis of earth, or within +45 to −45 degrees of the North or South axis. The long edges of each solar module may be parallel to the west-facing module column 108 or the east-facing module column 109.

FIG. 24B is a close-up view of a corner of the solar module array 100. In this array, the first solar modules 104 in both a west-facing module column 108 and an east-facing module column 109 are positioned over an extended mid-swivel bracket so that the centerline of the clip aperture 205 at each end of the bracket is a short distance 125 from the short edge of the solar module 104, the short edge also being the south edge of the solar module array 100. This distance 125 serves as a cantilever and may be up to 40% of the length of the solar module 104, preferably 20-30% of the length of the solar module 104. For example, if the solar module is 2000 millimeters long, the cantilever 125 may be up to 700 millimeters long. If the flange 123 on the module frame is 25 to 35 millimeters tall, or if the module is frameless, the cantilever may be limited to 250 to 600 millimeters. In some examples, the cantilever length 125 may be equal to the offset distance 512 of the clips.

As shown in FIG. 24B, the clips at the two ends of the extended mid swivel bracket 124 engage the frames of two adjacent modules, setting the cantilever lengths for each module. The two cantilever lengths on a given module may be equal or unequal. The extended mid swivel bracket 124 may be configured to place the opposing edges of two adjacent modules in contact with each other, or to leave a gap between them. The gap may for example be 1 to 100 millimeters in width. For enhanced stability, a single solar module may be supported by four module clips at the ends of four extended mid swivel brackets, each clip setting its own cantilever length 125.

FIG. 24C is a top-down view of the solar module array 100 from FIG. 24A. The NS length of the array at the end of the array may be chosen so that the module clips on the end swivel brackets 106 are placed on the end solar modules at a distance inward from the EW edges to form a cantilever length range 125. Extended mid swivel brackets 124 may be placed at the module junctures with their clips at similar cantilever lengths. All solar modules within the solar module array are thus clamped by four module clips, each clip positioned at a cantilever length. The cantilever 125 may have a smaller length for zone three solar modules along the periphery of the array, compared to zone one solar modules at the center of the array. Within a single solar module array 100, the zone one solar modules 119 (see FIG. 2) may utilize mid swivel brackets 107 and the zone two and zone three solar modules 121 may utilize extended mid swivel brackets 124. While the cantilevers may vary in length, preferred lengths are 250 to 600 millimeters. This length may apply to all modules in the array or be limited to the zone two and zone three modules. FIG. 24D is a close-up top view of a corner of the solar module array 100 depicted in FIG. 24C for added clarity. FIG. 24E depicts an isometric view of another corner of the solar module array 100.

FIG. 25 is an isometric view of an extended mid swivel bracket 124 installed on a stilt 101. The extended mid swivel bracket 124 includes an extended mid bracket piece 231 connected to a bracket coupler 200 in the same way described above for an end swivel bracket 106 and a mid swivel bracket 107. The extended mid bracket piece 231 has a cross-sectional shape that is the same as or different from the mid bracket piece 202 described above. A module clip 300 engages the extended mid bracket piece 231 in all the same ways as with an end bracket piece 201 or a mid bracket piece 202. The extended mid bracket piece 231 has a hollow hem 203 that is substantially similar to the hollow hem on the end bracket piece 201 or the mid bracket piece 202.

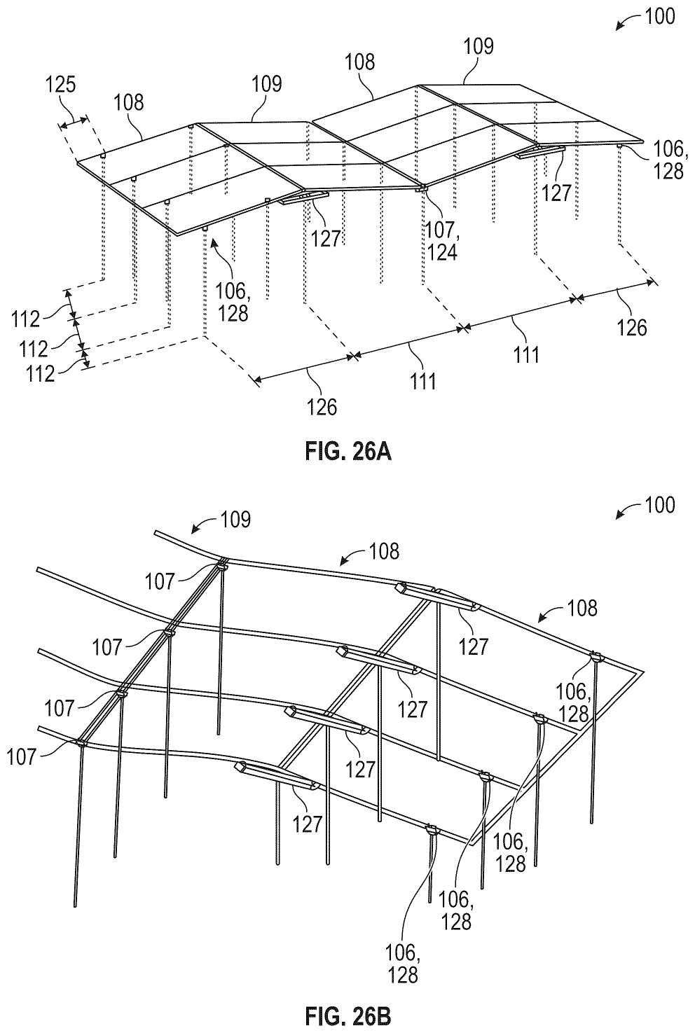

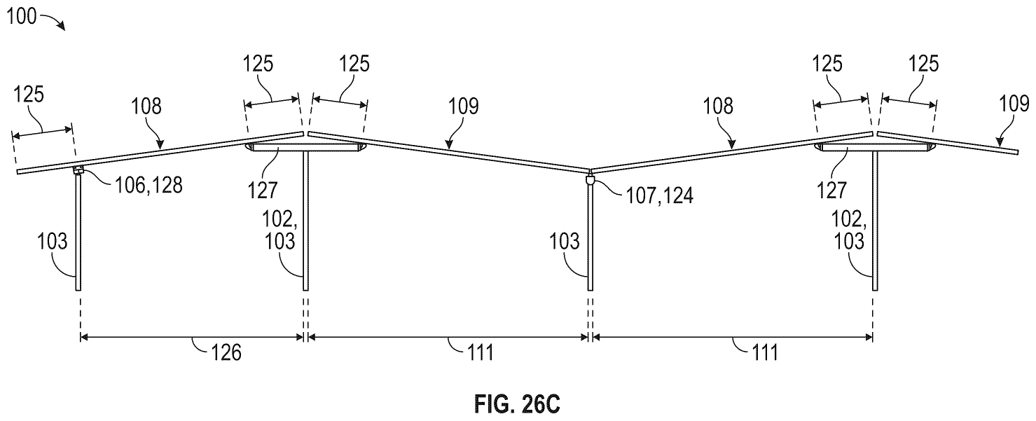

FIGS. 26A through 26C are views of a solar module array 100 with solar modules in portrait orientation, utilizing an alternative swivel bracket 105, still within the scope of the present invention. FIG. 26A is an isometric view of the solar module array as seen from above, and FIG. 26B is an isometric view as seen from below, with the terrain not shown. The array has alternating west-facing and east-facing module columns 108, 109. The module clips along the east-west (EW) edges of the modules at the column ends are positioned to leave cantilevers 125 at the north-south (NS) edges of the outermost modules. Crest span brackets 127 are installed on long stilts 102 and configured to place module clips 300 at sites that likewise form cantilevers 125. The cantilevers may be up to 600 millimeters in length, preferably limited to 250 to 600 millimeters, or a combination of different lengths. All solar modules in the western-most west-facing module column 108 and in the eastern-most east-facing module column 109 will be supported by module clips at sites that form cantilevers 125. Mid swivel brackets 107, extended mid swivel brackets 124, or a combination of end and mid swivel brackets may be installed on all short stilts 103 that are disposed between adjacent columns of long stilts 102.

FIG. 26C is an end view of one side of the solar module array 100. As variations of the arrangement shown in FIGS. 26A and 26B, the long stilts 102 may be replaced with short stilts 103, so that the crest span brackets 127 are installed on short stilts. Also, the module cantilever lengths 125 may be different on the western-most or eastern-most column of solar modules 104 than the cantilever lengths on interior columns.

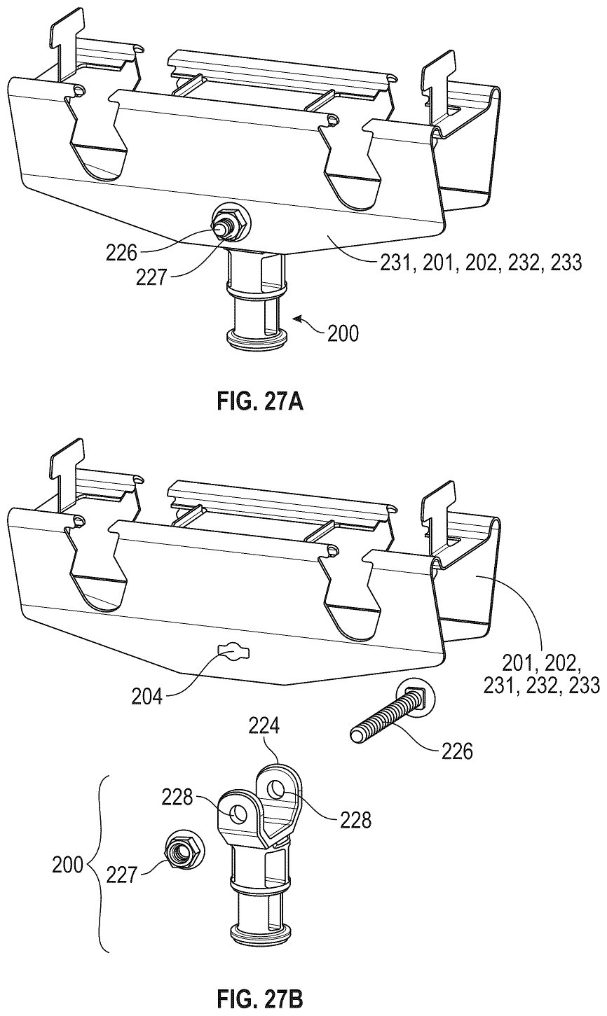

FIGS. 27A and 27B are isometric views of a swivel bracket 105 that uses a locking device to prevent rotation between the bracket coupler 200 and either an end bracket piece 201, a mid bracket piece 202, an extended mid bracket piece 231, a crest span bracket piece 232, or a universal bracket piece 233. In this example, the bracket coupler 200 has coupler apertures 228 through vertical flanges 224 to receive an axis fastener 226. The axis fastener 226 pivotally attaches the bracket coupler 200 to a mid bracket piece 202, for example. A locking fastener 227 threadably engages the axis fastener 226 so that when tightened, the locking fastener 227 and axis fastener 226 clamp the mid bracket piece 202 to the bracket coupler 200 to substantially prevent the bracket coupler 200 from pivoting around the axis of the axis fastener 226.

FIGS. 28A through 28D are isometric views of an alternative interface between a stilt and a swivel bracket, where the bracket coupler is replaced by a crimp tube 229 and the stilt is replaced by a male stilt 230. This configuration is applicable to all embodiments and assemblies of the solar module arrays described above. The male stilt 230 may be a solid or hollow cylinder, and may have a substantially smooth outer surface, or a ribbed, knurled, coarse, hatched, or grooved surface. The male stilt 230 may be coated steel rebar, coated steel, galvanized steel or aluminum. The crimp tube 229 may be hollow to allow insertion of the male stilt 230 into the tube. The crimp tube 229 may have sufficient ductility to allow a crimp 250 to be formed on the crimp tube after the tube is placed over the end of the stilt. The inside walls of the crimp tube 229 can thereby be sufficiently compressed over or conformed to a texture on the outside surface of the stilt 230 to prevent the crimp tube from sliding along the stilt 230 when exposed to a force up to a selected maximum force. Such a force may be greater than the force imposed on the stilt by through one or more connected solar modules (through the module clip 300 and the swivel bracket) due to wind forces. The stilt crimp 250 may take any of the forms described above and shown in FIG. 8. The crimp tube 229 may be made of coated steel, galvanized steel, aluminum, zinc alloy, or any other suitable corrosion resistant coating. The crimp tube may be secured to an end bracket piece 201, a mid bracket piece 202, an extended mid bracket piece 231, a crest span bracket piece 232, or a universal bracket piece 233 using one or more axis fasteners 226. The axis fastener 226 may be a rivet as shown.

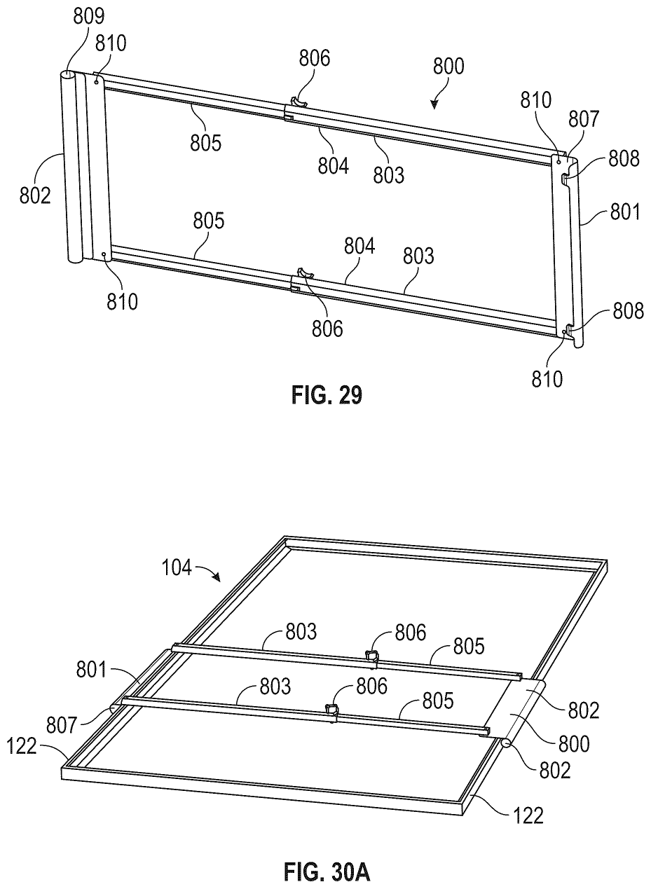

FIG. 29 is an isometric view of an installation jig 800 as an example of a device that can be used to align two stilts, one of which is installed on a terrain. The jig 800 has a bracket 801 for the installed stilt bracket plus a second bracket 802 connected to the first by one or more arms of adjustable length 803. The bracket 801 for the installed stilt has an alignment guide 807 along a vertical plane with one or more retention flanges 808 protruding from the alignment guide 807 for retaining the stilt. A flange extends from the first bracket 801 at one or more hinge points 810 on the flange surface. The second bracket 802 has a stilt alignment tube 809 to receive a stilt 101. The alignment tube 809 is arranged to hold the stilt substantially parallel to or substantially concentric with the installed stilt.

Each adjustable length arm 803 may consist of a first arm 804 and a second arm 805 joined together coaxially but capable of movement relative to each other to vary their combined length. The first and second arms have a telescoping connection, wherein the first arm slides inside a hollow portion of the second arm. Other possible connections are grooves, tracks, coupled flanges, sleeves, and barbed flanges. One or more arm locking devices 806 may be disposed on either arm and configured to releasably lock the position of the first arm 804 relative to the second arm. The arm locking device 806 may be a threaded fastener and nut, a cam-clamp, a clamp, a spring, a clasp, a latch, or any similar device. The two second arms 805 may be pivotally attached to the bracket for the installed stilt at the hinge points 810 and the two first arms 804 may be pivotally attached to the bracket 802 for the as-yet-uninstalled stilt at the opposing hinge points. When the length of the first adjustable length arm 803 is the same as that of the second adjustable length arm 803, the installation jig 800 may be configured so that when either adjustable length arm 803 is at an acute angle with the length of the installed stilt bracket 801, the axis of the installed stilt alignment guide 807 and the stilt alignment tube 809 are substantially parallel to each other. In this way, the installation jig 800 may take the form of a rhombus.

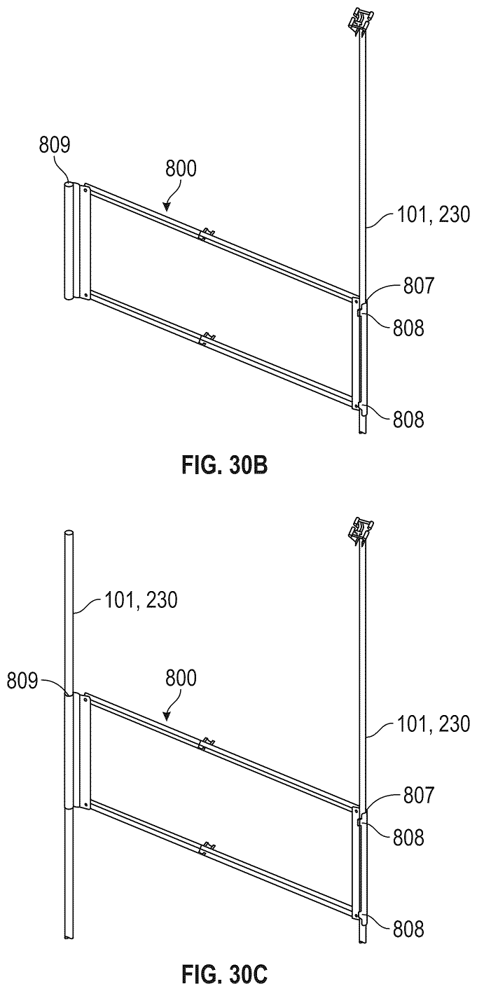

FIGS. 30A through 30D depict a method of using the installation jig 800 of FIG. 29 to align two stilts 101 during installation so that a to-be-installed solar module 104 aligns with an installed set of stilts 101. In FIG. 30A, the installation jig 800 is placed on top of a solar module 104 as the first step. The adjustable length arms 803 of the jig may be adjusted in length until the alignment guide 807 for the installed stilt and the stilt alignment tube 809 are at a desired distance laterally from the opposing edges of a solar module frame 122. Alternatively, the arm segments 803, 805 can be adjusted to the desired combined length before the jig is placed on the module so that the outer surfaces of the alignment guide 807 and the alignment tube 809 will be in contact with the edges of the module frame. The arm locking devices 806 may then be releasably locked to prevent any further change in length of the arms 803. FIG. 30A depicts the installation jig 800 being used on a solar module 104 that is in a portrait orientation, but the installation jig 800 may be turned at a right angle for use on a solar module in a landscape orientation. For a landscape orientation, the adjustable-length arms 803 will be placed may be substantially parallel to the long edge of the solar module.

In FIG. 30B, the installation jig 800 is temporarily engaged with a first stilt 101 that has been installed into the terrain, with the installed stilt alignment guide 807 on the jig being axially aligned with the first stilt 101, and with the jig retained on the stilt by retention flanges 808. The jig 800 is coplanar with the position sought for the next stilt, preferably along a marked line indicating where the first column of stilts is to be located. The lower surface or edge of the bracket 801 for the installed stilt and the lower surface of the stilt alignment bracket 802 may both abut the terrain, resulting in one or more adjustable length arms 803 being at an angle with the stilt 101 while the installed stilt alignment guide 807 and the stilt alignment tube 809 are still substantially parallel to each other.

FIG. 30C shows a second stilt placed inside and axially aligned with the stilt alignment tube 809, after which the second stilt is installed into the terrain. As the second stilt 101 penetrates the terrain through the stilt alignment tube 809, the stilt alignment tube 809 keeps the second stilt substantially parallel to the first stilt 101.

The installed stilt bracket 801 may then be decoupled from the first stilt by pivoting the installation jig 800 around the stilt alignment tube 809. The installation jig 800 may then be lifted up and removed from the second stilt 101. The entire procedure may then be repeated with the second stilt acting as the first stilt and a third stilt acting as the second stilt.

FIG. 31 is an isometric view of an alternative swivel bracket within the scope of the invention. This bracket is a universal swivel bracket 128 that uses a universal bracket piece 233 assembled with a bracket coupler 200. The universal bracket piece 233 has a side wall 215 that is substantially vertical and has one or more vertical ribs disposed on its surface.

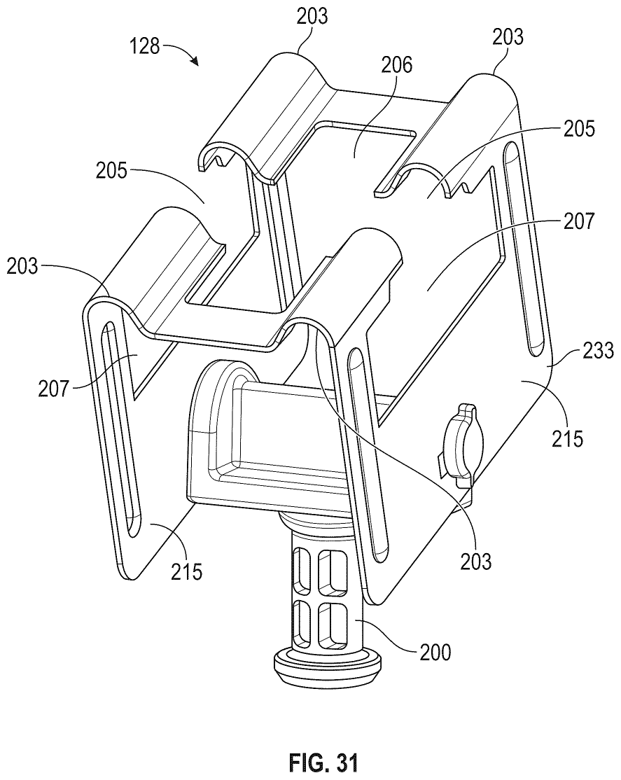

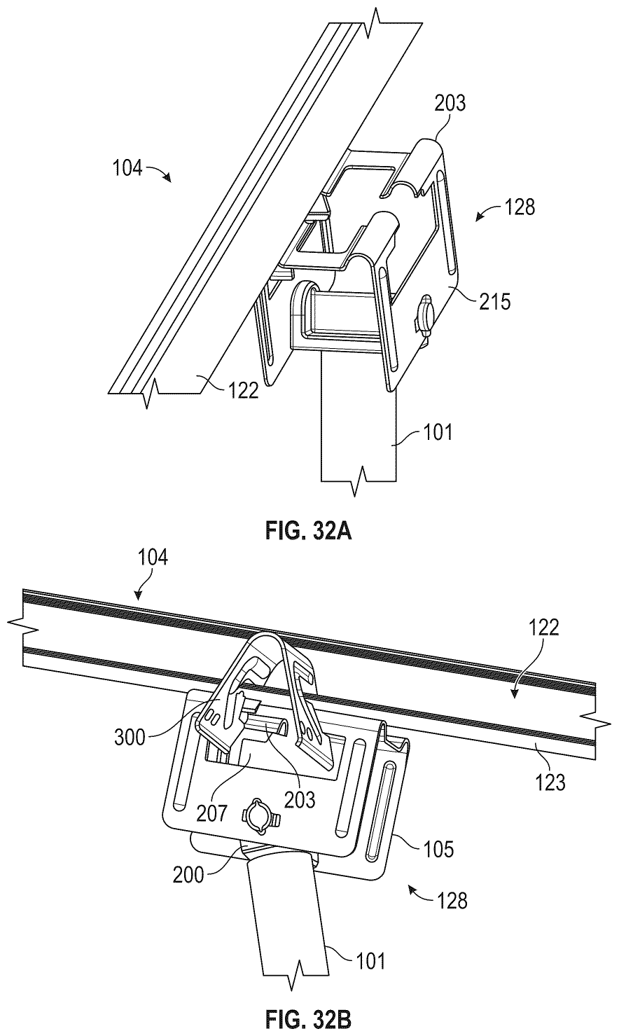

FIGS. 32A and 32B are isometric views of the universal swivel bracket 128 installed on a stilt 101, with a solar module 104 installed and clamped on one side of the bracket using a module clip 300.

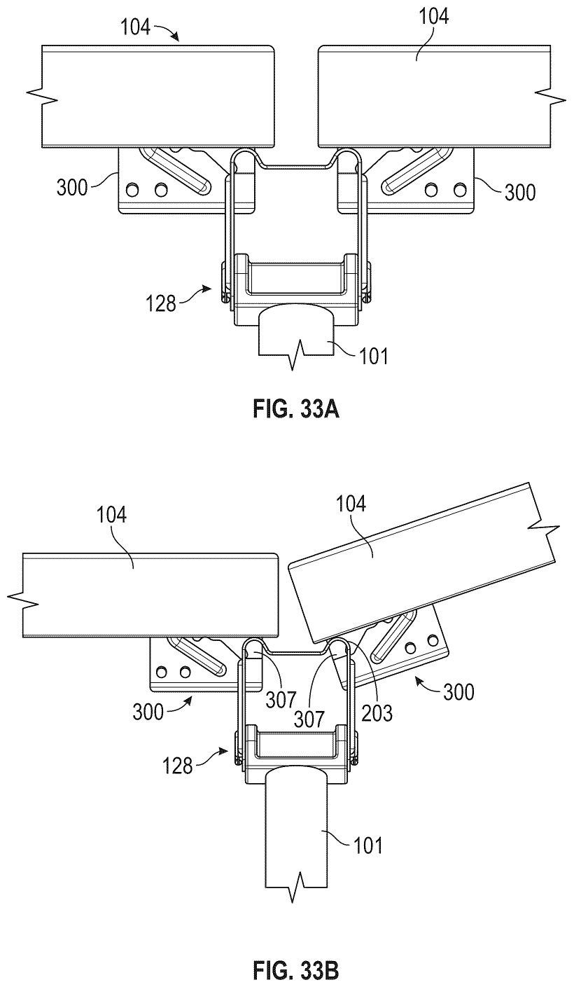

FIGS. 33A and 33B are end views of the universal swivel bracket 128 installed on a stilt 101 with a first solar module 104 installed on one side of the bracket using a first module clip 300) and a second solar module 104 installed on a second side of the bracket 128 using a second module clip 300. As shown in FIG. 33A, the first and second solar modules 104 are substantially co-planar. In FIG. 33B, the first and second solar modules are non-planar. The second solar module 104 and second module clip 300 are pivoted about a second hollow hem 203. Nevertheless, the clamping force that the second module clip imparts to the second solar module is the same magnitude as the clamping force that the first module clip 300 imparts to the first solar module.

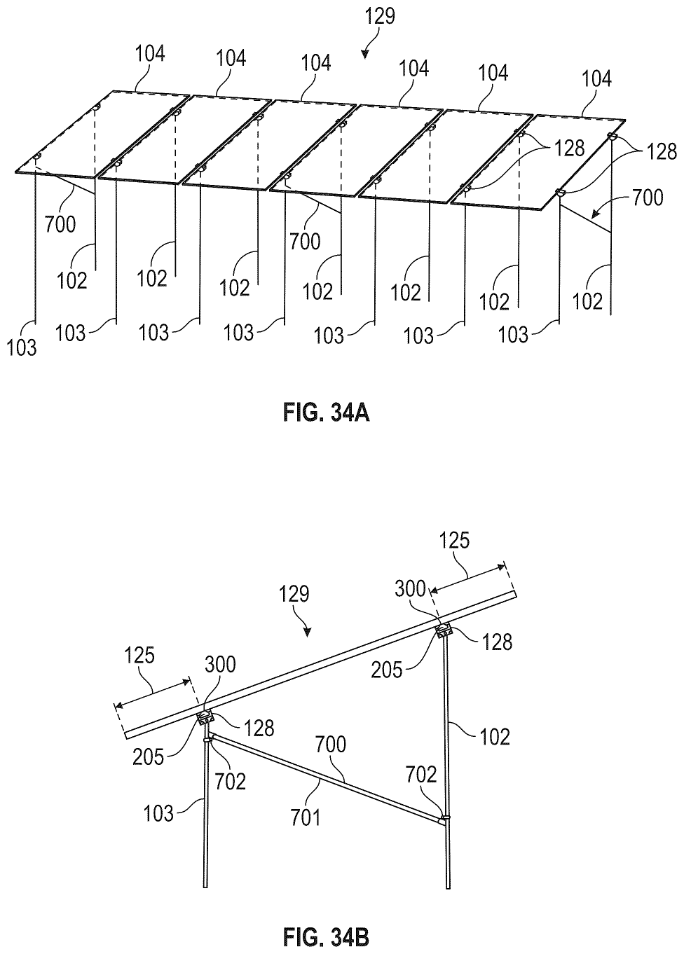

FIGS. 34A and 34B are isometric and end views of an equatorial facing solar array 129. In this array, a single row of solar modules 104 is supported by two rows of stilts. This equatorial facing solar array 129 consists of a first row of short stilts 103 and a second row of long stilts 102, with the long stilts 102 positioned farther from earth's equator than the short stilts. A universal swivel bracket may be installed on each stilt. The universal swivel brackets may be angled so that the hollow hems 203 are substantially concentric to align the solar module frames along the universal swivel brackets in a column of stilts. Long stilts 102 and short stilts 103 may be spaced apart so that the respective module clips 300 that clamp the solar modules 104 to the universal swivel brackets 128 form cantilevers.

One or more cross braces 700 may join each short stilt to a long stilt, preferably at an upper half of the short stilt. A cross brace 700 may be parallel to the solar module array or form an acute angle with the short stilt. The site where the cross brace is joined to the short stilt may thus be farther from the terrain than the site where the cross brace is joined to the long stilt. A cross brace may also join two long stilts at a non-perpendicular angle relative to the long stilts. A cross brace may consist of a cross brace bar 701 with a cross brace bracket 702 on both ends. The cross brace bar 701 may be a stilt cut to the length required for the spacing between a short stilt and a long stilt. The cross brace bar 701 may be the same material and same cross-sectional shape as a stilt. A cross brace bar may also take the form of a stilt, or it may be a cable, a braided cable, a rod, a threaded rod, or any other similar construction.

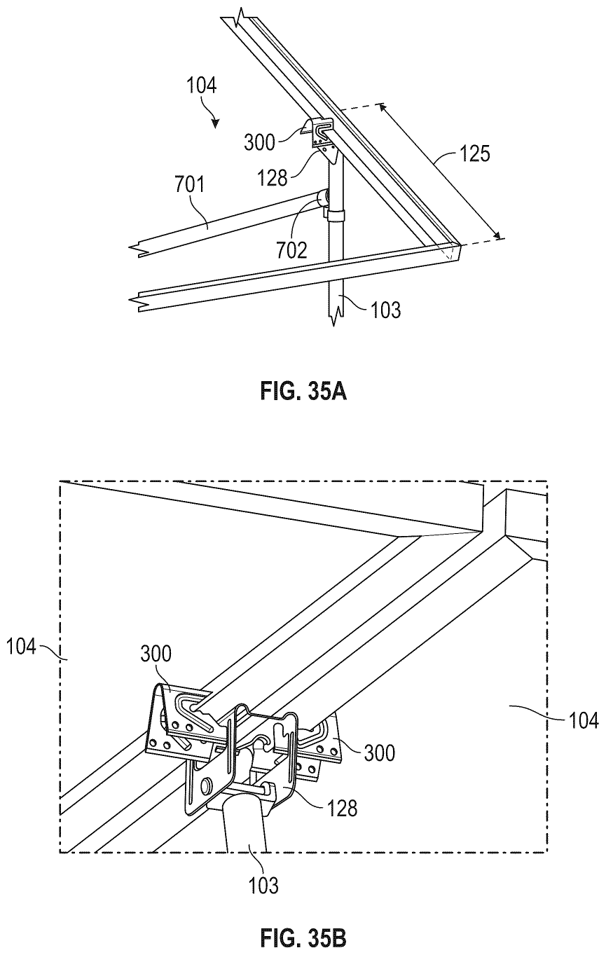

FIGS. 35A and 35B are isometric views of the universal swivel bracket from above and below, respectively. In FIG. 35A, the universal swivel bracket 128 supports a single solar module on one side of the bracket. In FIG. 35B, the bracket supports two solar modules.

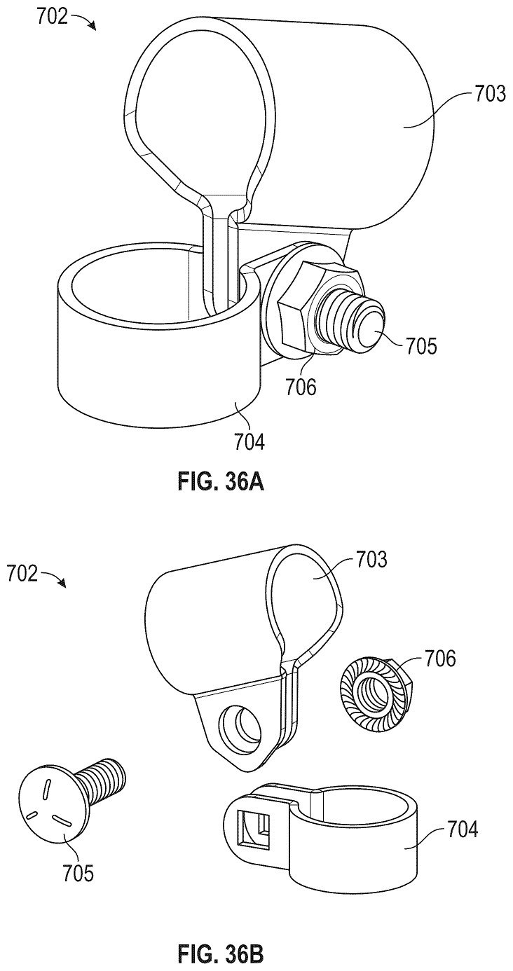

FIGS. 36A and 36B are assembled and exploded isometric views, respectively, of a cross brace bracket 702. The cross brace bracket includes a stilt brace piece 703 and a bar brace piece 704 connected to each other by a brace fastener 705 and nut 706. The stilt brace piece 703 has an inside diameter equal to or smaller than the exterior diameter of a stilt, and the bar brace piece 704 has an inside diameter equal to or smaller than the exterior diameter of cross brace bar. The stilt brace piece 703 and the bar brace piece 704 may be configured so that when the nut 706 threadably engages the brace fastener 705, the stilt brace piece 703 clamps onto the stilt 101 and the bar brace piece 704 clamps onto the cross brace bar 701. The bar brace piece 704 has an aperture 709 with at least one flat surface configured to engage a protrusion on the shank of the brace fastener 705 adjacent to the head of the shank to prevent the brace fastener 705 from rotating along its primary axis when the nut 706 is threadably engaged and rotated onto or off of the brace fastener 705. The brace fastener 705 may be a carriage bolt, for example. The cross brace 700 may also be configured to be installed on a solar module array 100 as shown in FIGS. 1, 24 and 26.

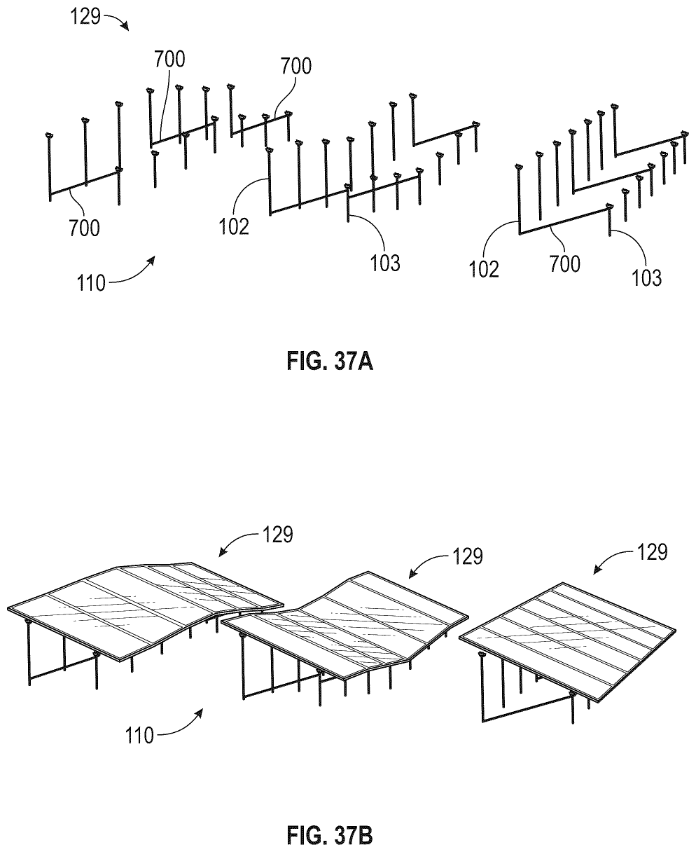

FIGS. 37A and 37B are isometric views from above of three equatorial facing solar arrays 129 that substantially follow changes in the surface of the terrain 110. The solar modules are removed in FIG. 37A to allow full visibility of the stilts. Cross braces 700 are installed on some of the pairs of long and short stilts. The number of cross braces 700 on a single array may vary depending on forces such as wind bearing on the array. In these Figures, the right-most equatorial facing module column of each array is on a substantially flat terrain, and thus the solar modules within this array 129 are substantially co-planar. The middle array in each Figure is installed on a concave or trough section of terrain, and the solar modules in this array are at angles less than 180 degrees to one another. The array on the left in each Figure is installed on a convex or hill section of terrain, and the solar module 104 are thus at angles greater than 180 degrees to one another. A single equatorial facing solar array may have solar modules that are co-planar, modules that are angled at less than 180 degrees with each other, and modules that are angled at more than 180 degrees with each other, in separate sections or in any combination of such sections.

In all figures presented, the solar laminate, glass, photovoltaic cells, or energy capture interface of any solar module 104 may be hidden from view in order to better understand the present invention. In many of these cases, only the solar module frame 122 is shown in the figures, but it should be understood that in all cases, it is conceived that the solar module 104 would be a complete and operational solar energy collection device, such as a solar photovoltaic module. In all examples provided, terrain 110 may be undisturbed land, graded land, dirt, soil, grass, grass, sand, rock, cobbles, landfills, compacted soils, farmland, fields, fields, hills, ditches, knolls, potholes, the surface of a planet, ground, or other installation surface.

What is claimed is:

1. A swivel bracket for securing solar modules at variable angles relative to a terrain, the swivel bracket comprising:
at least one side wall having a pivot connection configured to pivotally connect to a stilt coupler, wherein the pivot connection allows the at least one side wall to rotate about a first axis; and
one or more curved hems each extending along a respective edge of the at least one side wall, wherein the curved hems are configured to pivotally support a solar module, and wherein the supported solar module is rotatable around a second axis that is perpendicular to the first axis.

2. The swivel bracket of claim 1, wherein the at least one side wall includes a side access aperture sized to receive a module clip attached to an edge of the solar module.

3. The swivel bracket of claim 1, wherein the at least one side wall includes:
a first side wall,
a second side wall spaced from the first side wall so as to form an open space therebetween; and
a top wall that joins the first side wall to the second side wall.

4. The swivel bracket of claim 3, wherein the first side wall includes a first side access aperture, and the second side wall includes a second side access aperture, the first side access aperture sized to receive a module clip attached to an edge of the solar module, and the second side access aperture sized to receive a module clip attached to an edge of another solar module.

5. The swivel bracket of claim 3, further comprising a bracket coupler having a first end and a second end, wherein the open space is formed between the first side wall and the second side wall to receive the first end of the bracket coupler, and wherein the second end of the bracket coupler is configured to connect to a stilt.

6. The swivel bracket of claim 5, wherein the second end of the bracket coupler is sized to fit inside a hollow stilt.

7. The swivel bracket of claim 5, wherein the pivot connection includes an axis fastener that pivotally connects to the bracket coupler, wherein the at least one side wall is rotatable around the axis fastener.

8. The swivel bracket of claim 7, wherein the axis fastener includes a keyway in the at least one side wall that extends from one of the curved hems in a perpendicular direction and is sized to receive a key.

9. The swivel bracket of claim 5, wherein the bracket coupler is a hollow tube configured to fit as sleeve over a solid stilt.

10. The swivel bracket of claim 5, wherein the bracket coupler is crimped.

11. The swivel bracket of claim 3, wherein the top wall includes one or more central apertures that open into the open space, the central apertures extending into a side access aperture in at least one of the first side wall and the second side wall, and wherein a combined aperture of the central apertures and the side access aperture is sized to receive a module clip attached to an edge of the solar module.

12. The swivel bracket of claim 3, further comprising one or more module spacers orthogonally protruding from the top wall, wherein the module spacers abut side edges of a solar module.

13. The swivel bracket of claim 1, wherein the at least one side wall is formed from a material having uniform wall thickness.

14. The swivel bracket of claim 13, wherein the material has a thickness between 0.5 to 2.0 mm.

15. The swivel bracket of claim 13, wherein the material is steel with a corrosion protection coating.

16. The swivel bracket of claim 1, wherein the at least one side wall includes one or more cable holders configured to receive and hold one or more cables.

17. The swivel bracket of claim 1, wherein each of the curved hems has a hollow curvature configured to receive one or more tabs of a module clip attached to an edge of the solar module.

18. The swivel bracket of claim 1, wherein the pivot connection allows the supported solar module to pivot at least 15 degrees relative to the terrain along a first axis.

19. The swivel bracket of claim 1, wherein the curved hems allow the supported solar module to pivot at least 5 degrees relative to the at least one side wall along a second axis.

20. The swivel bracket of claim 1, wherein the at least one side wall has a span such that a distance between a centerline of a module clip aperture extends into a length of the supported solar module by 1 to 600 millimeters.

21. The swivel bracket of claim 1, further comprising one or more abutment flanges protruding from the at least one side wall, the abutment flanges abutting side edges of the supported solar module.

22. An apparatus for securing solar modules at variable angles relative to a terrain, the apparatus comprising:
a module clip that include:
a first side wall that includes one or more solar module flange apertures each configured to receive a solar module flange,
a second side wall that includes one or more solar module flange apertures each configured to receive a solar module flange,
a hem that joins the first side wall and the second side wall at an angle relative to each other, wherein the hem is compressible between an uncompressed state and a compressed state, and wherein the angle in the compressed state is smaller than the angle in the uncompressed state, and
one or more tabs; and
a swivel bracket configured to support a solar module and including one or more bracket walls through which an aperture extends, the aperture configured to receive the module clip when the module clip is in the compressed state and to retain the module clip when the module clip is in the uncompressed state, wherein the module clip is secured to an underside of the swivel bracket by the one or more tabs.

23. The apparatus of claim 22, wherein the module clip further includes an electrical bonding feature that extends into at least one of the solar module flange apertures and configured to penetrate a solar module surface to form an electrical bond path between the module clip and the solar module.

24. The apparatus of claim 22, wherein the module clip further includes a module compression flange extending from the first side wall and the second side wall into the solar module flange apertures, wherein the module compression flange is deflectable to allow insertion of a solar module into the solar module aperture and releasable to impart a compression force to the solar module when the solar module is inserted.

25. The apparatus of claim 22, wherein the bracket side walls include a first bracket side wall and a second bracket side wall that each include a curved hem with a curved profile, and wherein the module clip further includes a pair of opposing swivel grips each having a curved edge that nests against the curved profile of the curved hem.

26. The apparatus of claim 25, wherein the first bracket side wall includes a first side access aperture, and the second bracket side wall includes a second side access aperture, the first side access aperture and the second side access aperture each sized to receive the module clip in the compressed state and to prevent the module clip from passing further or sliding out when the module clip is in the uncompressed state.

27. The apparatus of claim 26, wherein edges of the aperture prevent the module clip from sliding along a length of the hem and dislodging swivel grips of the module clip from the swivel bracket when the module clip is in the uncompressed state.

28. The apparatus of claim 26, wherein the swivel bracket further includes a central aperture extending into the first side access aperture and the second side access aperture, and wherein a combined aperture of the central aperture, the first side access aperture, and the second side access aperture is sized to receive the clips attached to edges of two solar modules.

29. The apparatus of claim 22, further comprising a bracket coupler having a first end and a second end, wherein an open space is formed between the first side wall and the second side wall to receive the first end of the bracket coupler, and wherein the second end of the bracket coupler connects to a stilt.

30. The apparatus of claim 29, wherein the swivel bracket further includes an axis fastener that pivotally connects to the bracket coupler, and wherein the swivel bracket is rotatable around the axis fastener.

31. The apparatus of claim 30, wherein the axis fastener includes a keyway in the swivel bracket that extends from one of curved hems of the swivel bracket in a perpendicular direction and is sized to receive a key.

32. The apparatus of claim 22, wherein the walls of the swivel bracket include one or more cable holders configured to receive and hold one or more cables.

33. The apparatus of claim 22, wherein a vertical distance between an upper edge of a module flange aperture to a closest point on a hem is less than a thickness of a module frame flange of the solar module when the module clip is installed in a swivel bracket and in the uncompressed state.

34. The apparatus of claim 33, wherein a thickness of the module frame flange is between 1.2 to 2.5 mm.

35. The apparatus of claim 22, wherein the module clip is made of a material with a uniform thickness.

36. The apparatus of claim 35, wherein the material is steel with an elasticity that allows the module clip to spring back to an uncompressed state after being in a compressed state.

37. The apparatus of claim 35, wherein the material includes an anti-corrosion coating.

38. The apparatus of claim 22, wherein the module clip includes a clip hem that curves beyond 180 degrees from the hem, and wherein the first side wall of the module clip is angled out and away from the second side wall of the module clip by the clip hem.

39. The apparatus of claim 25, wherein the module clip rotates along an axis of the curved hem of the swivel bracket by at least 5 degrees.
